(19) United States
(12) Patent Application Publication
(10) Pub. No.: US 2025/0190541 A1
(43) Pub. Date: Jun. 12, 2025

(54) USER-DEFINED FUNCTION SECURITY FRAMEWORK

(71) Applicant: Cyral Inc., Milpitas, CA (US)

(72) Inventors: Narendra Vemula, Fremont, CA (US); Deepak Gupta, Riverside, CA (US); Guilherme Neri Andrade, Belo Horizonte (BR); Srinivas Nageswarrao Vadlamani, San Jose, CA (US)

(21) Appl. No.: 18/786,047

(22) Filed: Jul. 26, 2024

Related U.S. Application Data
(60) Provisional application No. 63/530,650, filed on Aug. 3, 2023.

(51) Int. Cl. G06F 21/53; G06F 21/60

(52) U.S. Cl. CPC G06F 21/53; G06F 21/604

(57) ABSTRACT

The present application discloses a method, system, and computer system for obtaining responses to a query. The method includes: (a) receiving, at a sidecar, a communication for a data source, (b) determining, by the sidecar, a policy corresponding to the communication, the policy identifying a user-defined function (UDF) corresponding to the policy, the UDF being stored by the data source, and (c) invoking the UDF based on the policy using the sidecar.

### CROSS REFERENCE TO OTHER APPLICATIONS

This application claims priority to U.S. Provisional Patent Application No. 63/530,650 entitled USER-DEFINED FUNCTION SECURITY FRAMEWORK filed Aug. 3, 2023 which is incorporated herein by reference for all purposes.

### BACKGROUND OF THE INVENTION

Conventional security models protect data and electronic assets by providing a secure perimeter around an organization. The secure perimeter includes not only the data sources, servers, and other analogous assets, but also clients employed by users of the assets. However, applications remain vulnerable, unscrupulous individuals may still obtain copies of sensitive data and administration of the secure perimeter may be complex and expensive. Further complicating security is that multiple users having different levels of authorization may have access to various secure databases. Access to various data may also be authorized based on groups to which users belong. Updating the users that are authorized to access various may be challenging. Tracking the activities of such users may also be challenging. In addition, data sources, such as conventional databases and modern data repositories including distributed message queues, may not be configured for other types of security, such as tokenization of data and federated identity management. Accordingly, an improved mechanism for providing security for data sources is desired

### BRIEF DESCRIPTION OF THE DRAWINGS

Various embodiments of the invention are disclosed in the following detailed description and the accompanying drawings.

FIG. 1 is an exemplary embodiment of a system including a protective layer at the data source.

FIG. 2 is another exemplary embodiment of a system including a protective layer at the data source.

FIG. 3 is another exemplary embodiment of a system including a protective layer at the data source.

FIG. 4 is a flow chart depicting an exemplary embodiment of a method for authenticating a client for a data source.

FIG. 5 is a flow chart depicting an exemplary embodiment of a method for performing services for a client for a data source.

FIG. 6 is a flow chart depicting an exemplary embodiment of a method for performing multi-factor authentication for a client for a data source.

FIG. 7 is a flow chart depicting an exemplary embodiment of a method for performing federated identity management for a client for a data source.

FIG. 8 is a flow chart depicting another exemplary embodiment of a method for authenticating a client for a data source using federated identity management.

FIG. 9 is a flow chart depicting an exemplary embodiment of a method for analyzing and logging information related to queries of a data source.

FIG. 10 is a diagram depicting an exemplary embodiment of an abstract syntax tree.

FIGS. 11A and 11B are flow charts depicting exemplary embodiments of methods for utilizing tokenization and/or encryption of sensitive data.

FIGS. 12A and 12B are flow charts depicting exemplary embodiments of methods for providing client information and for performing behavioral baselining for clients.

FIG. 13A is a block diagram of a system including a protective layer for a data source according to various embodiments.

FIG. 13B is a block diagram of a system including a protective layer for a data source according to various embodiments.

FIG. 14 is a flow diagram of a method for processing a query for data stored at a data source according to various embodiments.

FIG. 15 is a flow diagram of a method for processing a query for data stored at a data source according to various embodiments.

FIG. 16 is a flow diagram of a method for processing a query for data stored at a data source according to various embodiments.

FIG. 17 is a flow diagram of a method for providing a response to a query for data stored at a data source according to various embodiments.

FIG. 18 is a flow diagram of a method for providing a response to a query for data stored at a data source according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In recent years, the widespread adoption of cloud computing and microservices architectures has significantly transformed how applications are developed, deployed, and maintained. One of the core components of these architectures is the use of containers, which allow applications to run in isolated environments with their dependencies. To enhance the functionality, security, and observability of these applications, the sidecar pattern has emerged as a prominent design approach. A sidecar may be a helper application that runs alongside the main application, providing auxiliary functionalities without modifying the core application code.

As data-driven applications continue to proliferate, the need for efficient, secure, and policy-compliant data access mechanisms has become critical. Traditional methods of embedding business logic and policies directly within the application code or database queries pose several challenges, including increased complexity, reduced maintainability, and difficulties in ensuring consistent policy enforcement.

To address these challenges, various embodiments utilize a sidecar to process or rewrite queries for data stored at a data source. This approach leverages the sidecar to dynamically rewrite incoming queries to include or reference one or more user-defined functions (UDFs) that are stored locally at the data source. The UDFs encapsulate specific logic or policies that are to be enforced or applied during query processing or response determination. As an example, the sidecar receives (e.g., intercepts) a query from another system attempting to access data or store data at the data source. In response to receiving the query, the sidecar (e.g., a service running within or invoked by the sidecar) determines one or more UDFs to be applied in connection with determining a response to the query and modifies or rewrites the query in a manner to cause the data source to apply (e.g., locally execute) the UDF(s) at the data source.

As used herein, a UDF may include a custom function stored locally at the data source, designed to perform specific operations on data during query processing. These operations can include data transformation, masking, obfuscation (e.g., replacement of certain data with a predefined symbol such as an asterisk), filtering, enrichment, or enforcing business logic and policies. UDFs are dynamically incorporated into queries by a sidecar, based on the context and requirements determined by a policy engine. This approach ensures that the necessary logic is applied consistently and efficiently during data retrieval and processing, without requiring changes to the core application code.

Various embodiments provide a method, system, and computer system for obtaining responses to a query. The method includes: (a) receiving, at a sidecar, a communication for a data source, (b) determining, by the sidecar, a policy corresponding to the communication, the policy identifying a user-defined function (UDF) corresponding to the policy, the UDF being stored by the data source, and (c) invoking the UDF based on the policy using the sidecar.

Various embodiments provide a method, system, and computer system for obtaining responses to a query. The method includes: (a) receiving, at a dispatcher of a sidecar, a communication for a data source, the sidecar including the dispatcher and a plurality of services, (b) determining, by a first service, a policy corresponding to the communication, the policy identifying a user-defined function (UDF) corresponding to the policy, (c) providing, by a second service, an input communication for the data source, the input communication based on the UDF and the communication, (d) providing the input communication to the data source, and (e) returning a response to the input communication from the data source.

In some embodiments, the system (e.g., a sidecar) receives a query and generates an input communication to be provided to a data source in connection with obtaining a response to the query. In response to receiving the query, the system determines a policy to be enforced with respect to the query (e.g., in connection with the processing of the query, such as to obtain responsive data). The policy may identify that a particular UDF(s) is to be applied in connection with enforcing the policy. The system can configure an updated query to be sent to the data source (e.g., translate, rewrites, or modifies the query) based at least in part on the UDF. For example, the system rewrites the query so the updated query comprises at least part of the logic corresponding to the UDF. When the data source executes the updated query, the applicable UDFs (e.g., the UDFs incorporated into the updated query) are applied. For example, the application of the UDF does not require the data source to call/invoke a UDF, such as a UDF locally stored at the data source.

Various embodiments provide a method, system, and computer system for providing responses to a query. The method includes: (a) receiving, at a dispatcher of a sidecar, a communication for a data source, the sidecar including the dispatcher and a plurality of services, (b) determining, by a first service, a policy corresponding to the communication, the policy identifying a user-defined function (UDF) corresponding to the policy, (c) providing, by a second service, an input communication for the data source, the input communication based on the UDF and the communication, (d) providing the input communication to the data source, and (e) returning a response to the input communication from the data source.

Various embodiments provide a method, system, and computer system for providing responses to a query. The method includes: (a) obtaining a query for data stored in a data source, (b) determining a policy to be enforced with respect to the query, (c) obtain a query response based at least in part on (i) enforcement of the policy, and (ii) at least a subset of data responsive to the query, and (d) provide a response to the query. The policy can indicate one or more UDFs that are to be applied in connection with enforcing the UDFs. The UDFs can be locally stored at a sidecar for execution or use at the sidecar or otherwise accessible by the sidecar (e.g., the UDF may be stored in a remote library that the sidecar is configured to access). Additionally, or alternatively, the UDF may be stored locally at a data source for execution/application by the data source while processing a query (or rewritten query) from the sidecar. In some embodiments, the obtaining the query response to the query comprises: (1) rewriting the query to comprise at least part of the logic or functionality of the UDF(s) identified by the policy, (2) providing the rewritten query to the data source for execution, and (3) receiving from the data source a response to the rewritten query. In implementations in which the logic or functionality of the UDF is comprised in the rewritten query, the data source can apply the UDF without having to locally call/execute the UDF (e.g., the functionality of the UDF is comprised/inherent in the rewritten query).

In some embodiments, rewriting or configuring the query to comprise the logic or functionality of a UDF achieves the same effect as invoking the UDF (e.g., causing the data source to locally execute/call the UDF). The invoking of the UDF can be expensive, particularly when a large number of fields are impacted by the UDF. For example, in the case that the UDF is configured to mask certain data (e.g., sensitive/confidential data or data for which a user does not have requisite permission), the invocation of the UDF can be computationally expensive if a large number of fields are to be masked during processing of the query (and enforcement of the applicable policy). As an illustrative example, a sample query may be “SELECT ccn FROM customers”. In this case, ccn may refer to credit card numbers. The invocation of the UDF (e.g., the configuring an input communication to cause a data source to locally call/apply the UDF) may include generating an input communication based on the received query and the UDF to be applied (e.g., as identified by the applicable policy(ies)). Using the above example, the system (e.g., the sidecar) can generate an input communication as “SELECT constant_mask (ccn, “*****”) FROM customers”. This input communication causes the data source to locally call (e.g., execute/apply) the UDF when obtaining the credit card numbers from customer. Continuing with this example, in various embodiments, the system (e.g., the sidecar) rewrites the query to comprise the logic or functionality of the UDF so that the UDF does not need to be called by the data source. An example of the rewritten query is: “Select “****” FROM customers.

Various embodiments provide a method, system, and computer system for providing responses to a query. The method includes: (a) receiving, at a data source, an input communication querying a subset of data stored at the data source, (b) determining a user-defined function (UDF) to be applied in connection with determining a response to the input communication, wherein the UDF is determined based at least in part on an indication comprised in the input communication, (c) determining the response to the input communication, including applying the UDF, and (d) providing the response to the input communication based at least in part on an application of the UDF. The UDF is stored at the data source, and applying the UDF comprises executing the UDF locally at the data source. In some embodiments, the input communication is received by the data source from a side car that functions as a proxy between the data source and one or more of a client system, another system, or a service (e.g., a system or service querying or attempting to obtain data stored at the data source).

Various embodiments implement a sidecar proxy that receives (e.g., intercepts) queries from the main application (e.g., a client system) before they reach the data source. This proxy is responsible for analyzing and rewriting the queries as needed. The proxy (e.g., the sidecar) can invoke one or more services in connection with analyzing the queries, determining one or more applicable policies to be enforced with respect to the query, and rewriting or modifying the query in a manner that indicates or invokes a UDF to be applied at data source in connection with the query processing. The proxy can determine the one or more policies to be applied based at least in part on one or more of a characteristics of the other system or service, an account associated with the system or service, and/or a specific data or data type that is to be accessed in connection with the query.

In some embodiments, the sidecar proxy can modify the original query to include references to UDFs that are relevant to the query's context. This rewriting ensures that the necessary business logic or policies are applied during the query execution.

In some embodiments, the UDFs are pre-defined functions stored locally at the data source. They encapsulate specific operations, such as data transformation, filtering, or enrichment, which are applied to the data during query processing. The UDFs can be stored in a library locally at the data source. In response to determining that a UDF is to be applied (e.g., in connection with processing the query) based at least in part on the query (e.g., the rewritten query), the data source locally applies the UDF (e.g., the UDF is executed locally at the data source) in connection with (e.g., during) query processing.

The sidecar (e.g., the proxy or proxy service) can query a policy engine to determine which UDFs should be applied to a given query. The policy engine evaluates the context of the query, such as user roles, data sensitivity, or compliance requirements, and provides a list of UDFs to be enforced. In some embodiments, in the case that a plurality of policies are to be enforced with respect to a query, the sidecar can determine whether enforcement of the policies introduce a conflict, and in response to determining that a conflict is expected to be introduced by the enforcement of the plurality of policies, the sidecar determines a conflict resolution (e.g., a manner for resolving the expected conflict). Additionally, or alternatively, the sidecar similarly determines whether a plurality of UDFs are to be applied in connection with processing a query, and in response to determining that the plurality of UDFs are to be applied, the sidecar determines whether application of a plurality of UDFs for the query processing is expected to cause a conflict. In response to determining that application of the plurality of UDFs is expected cause a conflict, the sidecar determines a conflict resolution and causes the conflict resolution to be implemented. In some embodiments, the conflict resolution can be determined based at least in part on one or more predefined rules. The one or more predefined rules may be used in connection with determining a priority according to which the policies and/or UDFs are to be enforced/applied.

By configuring the data source to store UDFs locally at the data source, various embodiments ensure efficient execution and reduces the latency associated with remote function calls. This local storage also simplifies the management and versioning of UDFs. Executing or applying the UDFs at the sidecar may not be feasible given the amount/size of data to be processed in connection with the query processing. At scale, the amount of data to be processed can be significant and the transfer of data from the data source to the proxy for application of certain functions (e.g., UDFs) can be resource intensive and introduce undesirable latency to the query processing.

As used herein, a sidecar may include an application, service, or system/module that sits between a data source and a system interfacing with the data source (e.g., accessing, manipulating, or storing data within the data source). Examples of systems that interface with the include a client application or another system or service. In some embodiments, the sidecar may be instantiated or distinct from the data source. In other implementations, the sidecar may be a service or application that runs within the data source and mediates communication to/from the data source, such as by intercepting calls or communication to/from the other system interfacing with the data source. In other implementations, the sidecar may be a service or application that runs within the other system (e.g., the client system) attempting to interface with the data source.

In some embodiments, a sidecar is a secondary process or service that runs alongside a primary application, serving as an intermediary for managing and enhancing the interaction between the application and a data source. The sidecar intercepts queries directed to the data source and rewrites the queries to incorporate (e.g., to reference or otherwise indicate) UDFs that are stored locally at the data source. These UDFs encapsulate specific logic or policies, ensuring that they are applied during the query processing or response determination. By querying a policy engine, the sidecar can dynamically determine which UDFs to apply based on the context of the query, such as user roles or compliance requirements.

The ability to dynamically apply UDFs based on policies ensures that data access adheres to security and compliance requirements. Additionally, by decoupling business logic from application code and embedding it within UDFs, the system becomes more maintainable and easier to update. The implementation of a sidecar allows for the seamless addition of new functionalities without impacting the core application, thus supporting scalability. Moreover, local application (e.g., execution) of UDFs at the data source reduces network overhead and improves query performance.

A system including a processor and a memory is described. The processor may be configured to perform some or all of the method(s) described. In some embodiments, a computer program product embodied in a non-transitory computer readable medium is described. The computer program product includes computer instructions for performing some or all of the method(s) described herein.

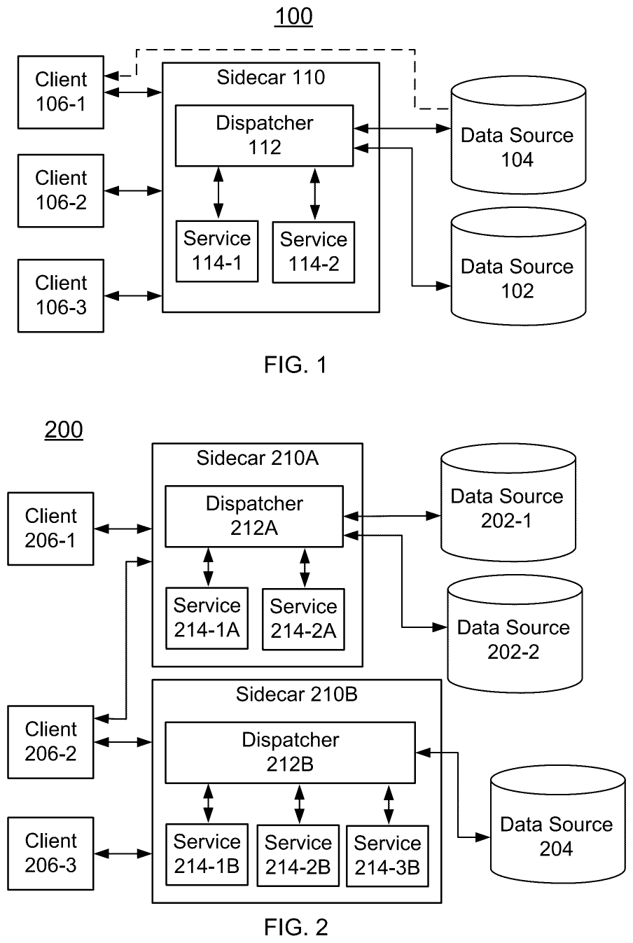

FIG. 1 is a diagram depicting an exemplary embodiment of a system 100 utilizing a protective layer between clients and data sources. System 100 includes data sources 102 and 104, clients 106-1, 106-2 and 106-3 (collectively clients 106) and sidecar 110. Although two data sources 102 and 104, three clients 106 and one sidecar 110 are shown, in another embodiment, different numbers of data sources, clients, and/or sidecars may be used. Data sources 102 and 104 may be databases, data stores, data vaults or other data repositories. Clients 106 may be computer systems for end users and/or include applications which provide requests, or queries, to data sources 102 and 104. Clients 106 may be part of the same organization as the data sources 102 and 104 or may be outside users of data sources 102 and 104. For example, clients 106 and data sources 102 and 104 may be part of the same business organization coupled by an internal network. In other embodiments, clients 106 may be outside users of data sources 102 and 104 connected to sidecar 110 and/or data sources 102 and/or 104 via the Internet or other external network. In some embodiments, some clients 106 may be external users of data sources 102 and 104 while other clients 106 are part of the same organization as data sources 102 and 104.

Sidecar 110 provides a protective layer between clients 106 and data sources 102 and 104. Sidecar 110 is configured such that its operation is data agnostic. Thus, sidecar 110 may be used with data sources 102 and 104 that have different platforms, are different databases, or are otherwise incompatible. Sidecar 110 is so termed because although depicted as residing between clients 106 and data sources 102 and 104, sidecar 110 may be viewed as enclosing, or forming a secure perimeter around data sources 102 and 104. Stated differently, clients 106 cannot bypass sidecar 110 in order to access data sources 102 and 104 in at least some embodiments. For example, a security group may be created for data sources 102 and 104. Dispatcher 112/sidecar 110 may be the only member of the security group. Thus, clients 106 may access data sources 102 and 104 only through sidecar 110. Clients 106 connecting to sidecar 110 may be internal or external to an organization. Therefore, sidecar 110 need not reside at the perimeter of an organization or network. Instead, sidecar 110 may reside at data sources 102 and 104. Stated differently, sidecar 110 may provide the final or only security for requests for data source 102 and 104 and need not provide security for other components of the organization. Thus, requests made by clients 106 may be passed directly from sidecar 110 to data sources 102 and 104 via a network.

Sidecar 110 provides security and other services for data sources 102 and 104 and clients 106. To do so, sidecar 110 includes dispatcher 112 and services 114-1 and 114-2 (collectively services 114). Dispatcher 112 is data agnostic and in some embodiments is a transport layer component (e.g. a component in Layer 4 of the Open Systems Interconnection (OSI) model). Dispatcher 112 thus performs limited functions and is not a Layer 7 (application layer) component. In particular, dispatcher 112 receives incoming communications from clients 106. As used herein, a communication includes a request, a query such as a SQL query, or other transmission from clients 106 to access data source 102 or 104.

Dispatcher 112 also provides the requests to the appropriate data source(s) 102 and/or 104 and the appropriate service(s) 114-1 and/or 114-2. However, dispatcher 112 does not inspect incoming communications from clients 106 other than to identify the appropriate data source(s) 102 and/or 104 and corresponding service(s) 114 for the communication. Dispatcher 112 does not make decisions as to whether communications are forwarded to a data source or service. For example, a communication from a client 106 may include a header indicating the data source 102 desired to be accessed and a packet including a query. In such a case, dispatcher 112 may inspect the header to identify the data source 102 desired to be accessed and forwards the packet to the appropriate data source 102. Dispatcher 112 also provides the packet to the appropriate service(s) 114. However, dispatcher 112 does not perform deep inspection of the packet. Instead, the appropriate service(s) inspect the packet. In some embodiments, dispatcher 112 provides the communication to the appropriate service(s) 114 by storing the packet and providing to service(s) 114 a pointer to the storage location.

In some embodiments, dispatcher 112 holds communications (e.g. packets) while service(s) 114 perform their functions. In other embodiments, dispatcher 112 directly forwards the communications to data source(s) 102 and/or 104 and services 114 separately perform their functions. In some embodiments, whether dispatcher 112 holds or forwards communications depends upon the mode in which dispatcher 112 operates. For example, in a step mode, dispatcher 112 may store some or all of the communication from client 106-1 without forwarding the communication to data sources 102 and 104. In such a mode, dispatcher 112 only forwards the communication to a data source if instructed to do so by the appropriate service 114 or if placed into stream mode by the appropriate service 114. Although not forwarding the communication to a data source, dispatcher 112 does provide the communication to service 114-1, for example for client 106-1 to be authenticated and/or for other functions. If client 106-1 is authenticated, dispatcher 112 may be placed in stream mode by service 114-1. Consequently, dispatcher 112 forwards the communication to the appropriate data source(s) 102. Because dispatcher 112 is now in stream mode, subsequent communications from client 106-1 may then be forwarded by dispatcher 112 directly to the appropriate data source(s) 102 and/or 104, even if the subsequent communications are also provided to a service 114 for other and/or additional functions. Thus, dispatcher 112 may provide the communication to the data source(s) as received/without waiting for a response from a service 114.

In some embodiments, responses from data source(s) 102 and/or 104 are also inspected by sidecar 110 and provided to clients 106 only if the responses are authorized. As used herein, a response from a data source may include data or other transmission from the data source to the client requesting access. In other embodiments, responses from data source(s) 102 and/or 104 may bypass sidecar 110 and be provided directly to clients 106. This is indicated by the dashed line from data source 104 to client 106-1. In the embodiment shown, therefore, data source 104 may bypass sidecar 110 and provide responses directly to client 106-1.

Services 114 provide security and other functions for data sources 102 and 104 and clients 106. For example, services 114 may include one or more of authentication, query analysis, query rewriting, caching, tokenization and/or encryption of data, caching, advanced or multifactor authentication, federated identity management, and/or other services. Further, one or more of the services described herein may be used together. Services 114 perform more functions than dispatcher 112 and may be application layer (Layer 7) components. In contrast to dispatcher 112, services 114 may perform a deeper inspection of communications from clients 106 in order to provide various functions. The services 114 performing their functions may thus be decoupled from forwarding of communications to data source(s) 102 and/or 104 by dispatcher 112. If a client or communication is determined by a service 114 to be unauthorized or otherwise invalid, the communication may be recalled, or canceled, from data source(s) 102 and/or 104 and connection to the client terminated. The communication may be recalled despite the decoupling of tasks performed by services 114 with forwarding of communications by dispatcher 112 because data sources 102 and 104 typically take significantly more time to perform tasks than services 114. The time taken by data source 102 and 104 may be due to issues such as transmission over a network from sidecar 110 to data sources 102 and 104, queues at data sources 102 and 104, and/or other delays.

In some embodiments, services 114 may perform authentication. For example, suppose service 114-1 validates credentials of clients 106 for data sources 102 and 104. In some such embodiments, service 114-1 may simply employ a username and password combination. In other embodiments, multifactor authentication (MFA), certificates and/or other higher level authorization is provided by one or more services 114. Such authentication is described herein. However, dispatcher 112 may still be a data agnostic component, such as a Layer 4 component.

In some embodiments, this separation of functions performed by dispatcher 112 and services 114 may be facilitated by routines or other lightweight process(s). For example, a client such as client 106-2 may request access to data source 104 via a particular port. Sidecar 110 may utilize listener(s) (not shown in FIG. 1) on the ports to identify requests for data sources 102 and 104. In response to the request for access, a connection to the client 106-2 is established for the sidecar 110 on that port and a routine corresponding to the connection generated. In some embodiments, the routine is responsible for that connection only. The communication from client 106-2 is also provided to dispatcher 112. Dispatcher 112 provides the communication to the appropriate service(s) 114 for authentication, for example via a message bus (not shown in FIG. 1). Dispatcher 112 may hold (in step mode) or forward (in stream mode) the communication to the data source(s) 102 and/or 104. If client 106-2 is not authenticated or is later determined by service(s) 114 to be unauthorized, then the service(s) 114 indicates this to dispatcher 112. For example, service(s) 114 may provide a message to dispatcher 112 via the message bus that client 106-2 is not authorized/that the corresponding routine has an unauthorized connection. Dispatcher 112 communicates with the corresponding routine, which terminates the connection to client 106-2. Thus, connections to clients 106 may be securely managed using data agnostic, Layer 4 dispatcher 112.

Using system 100 and sidecar 110, data sources 102 and 104 may be secured and other features may be provided via service(s) 114. Because of the use of data agnostic dispatcher 112, sidecar 110 may function with a variety of data sources 102 and 104 that do not share a platform or are otherwise incompatible. Deployment of sidecar 110, for example either in the cloud or on premises, does not require changes in existing code. Consequently, implementation of sidecar 110 may be seamless and relatively easy for developers. Further, sidecar 110 need not protect every component within a particular organization. Instead, only selected data sources may be protected. Use of services 114 for security as described herein may be both more effective at securing sensitive data and less expensive because data sources may not significantly increase in number even when the number of applications that access the data sources grows significantly. Further, utilizing services 114, the level of security and/or functions provided by sidecar 110 may differ for different data sources. Additional functionality may also be provided by services 114.

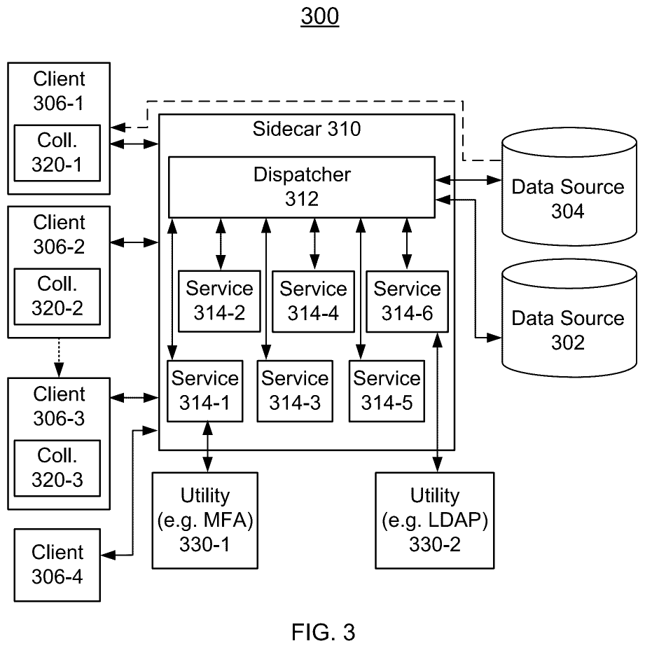

FIG. 2 is a diagram depicting another exemplary embodiment of a system 200 utilizing a protective layer between clients and data sources. System 200 is analogous to system 100 and includes components that are labeled similarly. System 200 indicates that multiple sidecars having different services may be used. Thus, system 200 includes data sources 202-1, 202-2 (collectively 202) and 204, clients 206-1, 206-2 and 206-3 (collectively clients 206) and sidecars 210A and 210B (collectively sidecars 210). Although three data sources 202-1, 202-2 and 204, three clients 206 and two sidecars 210 are shown, in another embodiment, different numbers of data sources, clients, and/or sidecars may be used. Data sources 202-1, 202-2 and 204 and clients 206 are analogous to data sources 102 and 104 and clients 106, respectively. Sidecars 210A and 210B are analogous to sidecar 110. Thus, sidecar 210A includes dispatcher 212A and services 214-1A and 214-2A (collectively services 214A). Similarly, sidecar 210B includes dispatcher 212B and services 214-1B, 214-2B and 214-3B (collectively services 214). Services 214A may differ from or be included in services 214B. Sidecar 210A controls access to data sources 202, while sidecar 210B controls accesses to data source 204 in a manner analogous to described elsewhere herein. In general, one sidecar having multiple services may function for all the data sources in an organization. However, as depicted in FIG. 2, nothing prevents the use of multiple sidecars. Further, although sidecars 210A and 210B are shown as controlling access to different data sources 202 and 204, in other embodiments, sidecars may control the same data source. For example, in another embodiment, sidecar 210B might serve both data source 202-1 and data source 204.

FIG. 3 is a diagram depicting another exemplary embodiment of a system 300 utilizing a protective layer between clients and data sources. System 300 is analogous to systems 100 and 200 and includes components that are labeled similarly. System 300 also includes collector 320-1, 320-2 and 320-3 (collectively collectors 320). Thus, system 300 includes data sources 302 and 304, clients 306-1, 306-2 and 306-3 (collectively clients 306) as well as client 306-4 and sidecar 310. Although two data sources 302 and 304, four clients 306 and one sidecar 310 are shown, in another embodiment, different numbers of data sources, clients, and/or sidecars may be used. Data sources 302 and 304 and clients 306 are analogous to data sources 102 and 104 and clients 106, respectively. Sidecar 310 is analogous to sidecar 110. Thus, sidecar 310 includes dispatcher 212 and services 314-1, 314-2, 314-3, 314-4 and 314-5 (collectively services 314). Sidecar 310 controls access to data sources 302 and 304. Also shown are utilities 330-1 and 330-2 that might be used by services 314. For example, service 314-1 might perform authentication and multifactor authentication using utility 330-1. Service 314-6 may perform federated identity management using utility 330-2. Other and/or additional utilities may be used in connection with system 300, as well as with system(s) 100 and/or 200. Service 314-2 might perform query analysis as described herein. Service 314-3 might perform behavior modeling based on inputs from collectors 320. Service 314-4 may perform tokenization and/or encryption of sensitive data. Service 314-5 may rewrite queries based on the analysis performed by service 314-2. Alternatively, service 314-2 might also rewrite queries. Thus, service 314-5 might perform another function such as caching. Other services not described herein may also be provided. Two or more services may be used together in some embodiments

Collectors 320 reside on some clients 306 (e.g., clients 306-1, 306-2, 306-3). In some embodiments, each of the clients includes a collector. In other embodiments, as shown in FIG. 3, not all clients 306 include a collector. In some embodiments, none of clients 306 includes a collector. For example, clients 306 may include end users, applications, and/or microservices utilized by end users. Thus, clients 306 may pass communications to each other prior to the communication being provided to sidecar 310. This is indicated by dotted line between client 306-2 and client 306-3. Collectors 320 intercept communications from clients 306 and append onto the communication a state of the client/application issuing the communication. For example, collector 320-1 may intercept a query or method call from the application on client 306-1 and examine the state of the application. The type of session, get/put/post/delete commands, APIs, IP address, query attributes, method calls, order of queries etc. may be detected by collector 320-1. These represent the context of the query/communication. Collectors 320 attach this context to the query/communication from the corresponding clients 306. In the case of microservices/multiple applications passing a query before the query is sent to a data source, the collectors 320 for each of the microservice/applications (e.g., clients 306) may apply the context from that microservice/application. For example, a query passed from client 306-2 to client 306-3 and then to sidecar can include a first context provided by collector 320-2 and a second context provided by collector 320-3. If one or more of clients 306 being passed a query does not include a collector, then that client simply does not attach the context from the client. For example, if a query is passed from client 306-1 to client 306-4, then to client 306-3, a first context from collector 320-1 and a second context from collector 320-3 are attached to the query. In such embodiments, no context is attached by client 306-4 because no collector is present for client 306-4. The query and context(s) are passed to sidecar 310 when data source 302 or 304 is accessed. Over multiple accesses, the contexts can be used by sidecar 310 (e.g. a service such as service 314-3) to determine the behavior (sequence of states/contexts) for each application's accesses of data source(s) 302 and/or 304. A model of the behavior (e.g. using a Hidden Markov Model) can provide a behavioral baseline. Subsequent accesses are compared to the baseline by service 314-3 to determine whether a current query/communication matches the baseline. If not, additional validation/defense mechanisms may be employed. For example, the connection may be terminated as described herein, access to data source 302 and/or 304 may be otherwise denied and/or additional forms of validation such as MFA may be utilized via services 314.

System 300 may provide the benefits of systems 100 and/or 200. In addition, system 300 may improve security via collectors 320. Further, end-to-end visibility, from clients 306 to data sources 302 and 304, may be provided via sidecar 310. Thus, performance of system 300 may be improved.

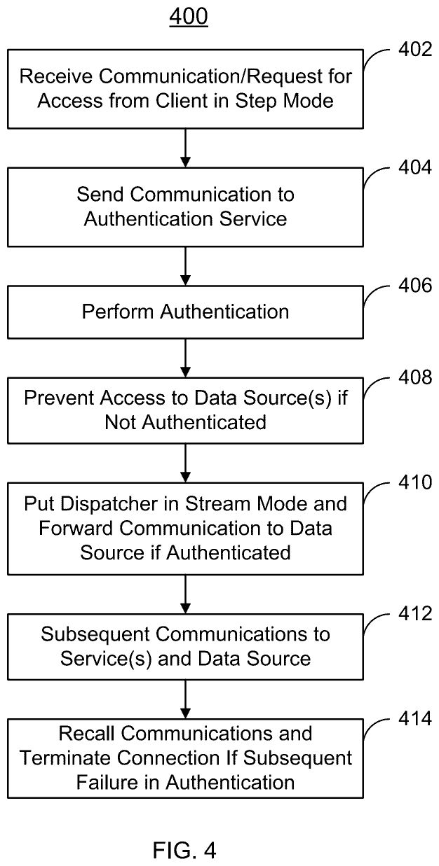

FIG. 4 is a flow chart depicting an exemplary embodiment of method 400 for authenticating a client for a data source. Method 400 is described in the context of system 100. However, method 400 may be used in connection with other systems including but not limited to systems 200 and 300. For simplicity, certain steps of method 400 are depicted. Method 400 may include other and/or additional steps and substeps. Further, the steps of method 400 may be performed in another order including performing portions or all of some steps in parallel. Method 400 may be carried out each time a client commences a session for communication with a data source.

Dispatcher 112 of sidecar 110 receives a communication requesting access to one or more data sources from a client, at 402. For example, dispatcher 112 may receive a communication requesting access to data source 102 from client 106-1. The communication may be received at dispatcher 112 after a connection between sidecar 110 and client 106-1 is established and a corresponding routine or other corresponding lightweight process generated. In addition to identifying data source 102 and client 106-1, the request may also include credentials for client 106-1. In some embodiments, at the start of method 400, dispatcher 112 is in step mode. At 404, therefore, dispatcher 112 provides the communication from client 106-1 to service 114-1, which performs authentication. For example, dispatcher 112 may send the payload of the communication to service 114-1 via a message bus (not separately labeled in FIG. 1). However, because dispatcher 112 is in step mode, dispatcher 112 does not also forward the communication to the requested data source 102. Further, because dispatcher 112 is a data agnostic component such as a Layer 4 component, dispatcher 112 does not perform a deeper inspection of the communication. Instead, dispatcher 112 simply holds (e.g. stores) the communication because dispatcher 112 is in step mode. If dispatcher 112 were in stream mode, dispatcher 112 would also forward the packet to the appropriate data source 102.

Service 114-1 performs authentication of client 106-1, at 406. In some embodiments, a certificate and/or other credentials such as a username and password may be used to perform authentication. In some embodiments, MFA (described in further detail below) may be used. In addition, if collectors such as collectors 320 are present in the system, the context of the communication provided by client 106-1 may be used in authentication at 406. For example, the context appended to the communication by a collector 320 may be compared to a behavior baseline modeled by system 100 from previous communications by client 106-1 to determine whether the context sufficiently matches previous behavior. Other and/or additional authentication mechanisms may be used in some embodiments.

If the client requesting access is not authenticated, then access to the data source is prevented, at 408. For example, the routine corresponding to the connection with client 106-1 may be notified and the connection terminated. Other mechanisms for preventing access may also be used. The communication held by dispatcher 112 is also discarded. In other embodiments, if dispatcher 112 had forwarded the communication to data source 102, then the communication is recalled at 408.

If the client is authenticated, then at 410, dispatcher 112 is placed in stream mode at 410. As a result, the communication being held is forwarded to the selected data source 102 at 410. In addition, future communications corresponding to the authenticated connection with client 106-1 are forwarded to the selected data source 102 and appropriate service(s) 114, at 412. For example, service 114-1 may provide a message to dispatcher 112 changing dispatcher 112 from step mode to stream mode at 410. Consequently, dispatcher 112 also forwards the communication to corresponding data source 102. Future communications received at dispatcher 112 from client 106-1 via the same connection may be both provided to one of the services 114 and to the selected data source 102. Thus, clients 106 are allowed to request and receive data from data source 102. However, authentication may still continue. For example, behavioral baselining described herein, periodic requests to revalidate credentials or other mechanisms may be used, at 414. If client 106-1 loses its authentication, then communications from the client to the selected data source may be recalled and further access to the data source blocked, at 414. For example, the routine responsible for the connection to client 106-1 may be notified and the connection terminated. Thus, connection to clients 106 may be securely managed using dispatcher 112 that is a data agnostic component, such as a Layer 4 component.

Using method 400, data sources 102 and 104 may be secured. Because of the use of data agnostic dispatcher 112, sidecar 110 may function with a variety of data sources 102 and 104 that do not share a platform or are otherwise incompatible. Deployment of sidecar 110, for example either in the cloud or on premises, may require no change in existing code. Consequently, implementation of sidecar 110 may be seamless and relatively easy for developers. Further, sidecar 110 need not protect every component within a particular organization. Instead, only selected data sources may be protected. Use of services 114 for security as described herein may be both more effective at securing sensitive data and less expensive because data sources may not significantly increase in number even when the number of applications that access the data sources grows significantly. Further, utilizing services 114, the level of security and/or functions provided by sidecar 110 may differ for different data sources.

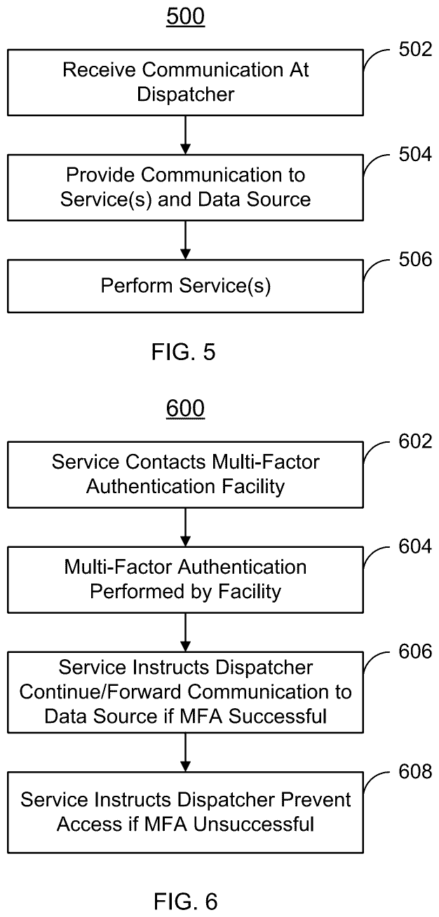

FIG. 5 is a flow chart depicting an exemplary embodiment of method 500 for performing one or more services for a client and a data source. Method 500 is described in the context of system 100. However, method 500 may be used in connection with other systems including but not limited to systems 200 and 300. For simplicity, certain steps of method 500 are depicted. Method 500 may include other and/or additional steps and substeps. Further, the steps of method 500 may be performed in another order including performing portions or all of some steps in parallel. In some embodiments, method 500 may be considered to be operable once authentication of the client is completed and dispatcher 112 is in stream mode.

Dispatcher 112 of sidecar 110 receives a communication from a client, at 502. For example, dispatcher 112 may receive a communication from client 106-2 with a query for data source 104. One or more services 114 are desired to be used with the communication. Therefore, dispatcher 112 provides the communication from client 106-2 to service(s) 114, at 504. In addition, dispatcher 112 forwards the communication to the requested data source 104 at 504. Stated differently, dispatcher 112 provides the relevant portions of the communication to both the desired data source(s) and service(s). Because dispatcher 112 is a data agnostic component such as a Layer 4 component, dispatcher 112 does not perform a deeper inspection of the communication. Instead, dispatcher 112 simply forwards the communication both to the desired data source(s) 102 and/or 104 and to service(s) 114 for further processing.

The desired functions are provided using one or more of the services 114, at 506. This may include inspecting the communication as well as completing other tasks. For example, at 506, services 114 may be used for authentication of various types, query analysis, federated identity management, behavioral modeling, query rewriting, caching, tokenization or encryption of sensitive data and/or other processes. Services 114 may thus be Layer 7 components. However, tasks performed by services 114 are decoupled from forwarding of the communication to data sources by dispatcher 112.

Using method 500 and sidecar 110, data sources 102 and 104 may be secured and other features may be provided via service(s) 114. Because of the use of data agnostic dispatcher 112, sidecar 110 may function with a variety of data sources 102 and 104 that do not share a platform or are otherwise incompatible. Functions performed by services 114 are decoupled from forwarding of communications to the data sources by dispatcher 112. Thus, a variety of features may be provided for data sources 102 and 104 without adversely affecting performance of data sources 102 and 104. Consequently, performance of system 100 may be improved.

FIG. 6 is a flow chart depicting an exemplary embodiment of method 600 for performing multifactor authentication (MFA) for a client and a data source. Method 600 is described in the context of system 300. However, method 600 may be used in connection with other systems including but not limited to systems 100 and 200. For simplicity, certain steps of method 600 are depicted. Method 600 may include other and/or additional steps and substeps. Further, the steps of method 600 may be performed in another order including performing portions or all of some steps in parallel. In some embodiments, method 600 may be considered to be used in implementing 406 and/or 506 of method 400 and/or 500. For the purposes of explanation, suppose service 314-1 provides multi-factor authentication. Method 600 may be considered to start after the MFA service 314-1 receives the communication from dispatcher 312. Further, dispatcher 312 may be in step mode at the start of method 600. Thus, dispatcher 312 may hold the communication instead of forwarding the communication to data source(s). In other embodiments, dispatcher 312 may be in stream mode. Dispatcher 312 may, therefore, may also provide the communication to the appropriate data sources. MFA may be performed in addition to other authentication, such as certificate or user identification/password based authentication, performed by service 314-1 or another service. Although described in the context of authentication for access to a single data source, in some embodiments, method 600 may be used to authenticate client(s) for multiple data sources.

Service 314-1 calls a MFA utility 330-1, at 602. The MFA utility 330-1 contacted at 602 may be a third party MFA such as DUO. Alternatively, the MFA utility 330-1 may be part of the organization to which data source(s) 302 and/or 304 belong. MFA utility 330-1 performs multi-factor authentication for the requesting client, at 604. For example, suppose end user of client 306-2 has requested access to data source 304. The user identification and password may have been validated by service 314-1. At 602, the MFA utility 330-1 is called. Thus, the end user is separately contacted by MFA utility 330-1 at 604 and requested to confirm the user's identity by the MFA facility. For example, the end user may be required to enter a code or respond to a prompt on a separate device. As part of 604, service 314-1 is informed of whether the multi-factor authentication by MFA utility 330-1 is successful. Stated differently, as part of 604, service 314-1 receives from MFA utility 330-1 a success indication. The success indication informs MFA utility 330-1 of whether or not MFA authentication was successful.

If the multi-factor authentication by MFA utility 330-1 is successful, then service 314-1 instructs dispatcher 312 to forward communications to the requested data source 304, at 606. In some embodiments, in response to receiving a positive success indication (i.e. that MFA authentication is successful), service 314-1 directs dispatcher 312 to forward communications to the requested data source 304. In some embodiments, dispatcher 312 is instructed to change from step mode to stream mode at 606. Thus, subsequent communications may be provided both to the data source 304 and one or more service(s) 314. In other embodiments, dispatcher 312 is simply allowed to continue forwarding communications to data source 304 at 606. If, however, multifactor authentication was unsuccessful, service 314-1 instructs dispatcher 312 to prevent access to the requested data source 304, at 608. For example, in response to receiving a negative success indication (i.e. that MFA authentication is unsuccessful), service 314-1 directs dispatcher 312 to prevent access to the requested data source 304. In response, dispatcher 312 may instruct the corresponding routine to terminate the connection with the requesting client 106. If the communication has already been forwarded to data source 304, then dispatcher 312 also recalls the communication. In some embodiments, dispatcher 312 may be instructed to remain in step mode and the client requested to resubmit the credentials and/or another mechanism for authentication used. In some embodiments, other action(s) may be taken in response to MA being unsuccessful.

Using method 600 MFA may be provided for data source(s) 302 and/or 304 in a data agnostic manner. Certain data sources, such as databases typically do not support MFA. Thus, method 600 may provide additional security to such data sources without requiring changes to the code of data sources 302 and 304. Security of system 100 may thus be improved in a simple, cost effective manner.

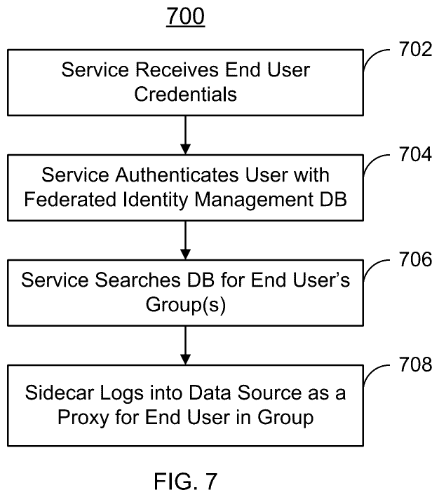

FIG. 7 is a flow chart depicting an exemplary embodiment of method 700 for performing federated identity management for a client for a data source. Federated identity management allows end users to access various facilities in an organization, such as multiple databases, email, analytics or other applications, based on a group identity and using a single set of credentials. For example, an end user may be a data analyst in a finance department. The end user may thus be considered a member of three groups: employees, data analysts and the finance department. A user identification and password for the end user may allow the end user to access their company/employee email, applications for the finance department, databases including information used by the finance department such as financial projections for the organization, analytics applications accessible by data analysts and other data based on the end user's membership in various groups within the organization. Federated identity management may use protocols such as lightweight directory access protocols (LDAP) and directories defining the groups to which each end user belongs.

Method 700 is described in the context of system 300. However, method 700 may be used in connection with other systems including but not limited to systems 100 and 200. For simplicity, certain steps of method 700 are depicted. Method 700 may include other and/or additional steps and substeps. Further, the steps of method 700 may be performed in another order including performing portions or all of some steps in parallel. In some embodiments, method 700 may be considered to be used in implementing 506 of method 500. For the purposes of explanation, service 314-6 is considered to provide federated identity management. Method 700 may be considered to start after service 314-6 receives the communication from dispatcher 312.

Service 314-6 receives the end user's credentials, at 702. For example, dispatcher 312 forwards to service 314-6 a communication requesting access to data source 302. The communication may include the end user's user identification and password for federated identity management. In other embodiments, the end user credentials are otherwise associated with the communication but are provided to service 314-6. Service 314-6 authenticates the end user with a federated identity management utility or database 330-2, such as an LDAP directory, at 704. To authenticate the end user the user identification and password are utilized. Service 314-6 searches the federated identity management database 330-2 for the group(s) to which the end user belongs, at 706. Using one or more of the group(s) of which the user is a member, sidecar 310 logs onto the data source 302 as a proxy for the end user, at 708. The end user may then access data source 302 in accordance with the privilege and limitations of the group(s) to which the end user belongs.

Using method 700, federated identity management can be achieved for data source(s) 302 and/or 304. Some databases do not support federated identity management. Method 700 and sidecar 310 having data agnostic dispatcher 312 may allow for federated identity management for such databases without changes to the databases. Thus, an end user may be able to access the desired data sources. Further, the organization can manage access to the data sources using groups in the federated identity management database. This may be achieved without requiring changes to data sources 302 and 304. Because sidecar 310 accesses data sources 302 and/or 304 as a proxy for the end user, sidecar 310 may log activities of the end user. For example, federated identity management service 314-6 may store information related to queries performed by the end user as well as the identity of the end user. Thus, despite using federated identity management to allow access to applications and data sources based on groups, the organization may obtain visibility into the activities of individual end users. In addition to improving ease of administration via federated identity management, improved information and control over individuals' use of data sources 302 and 304 may be achieved.

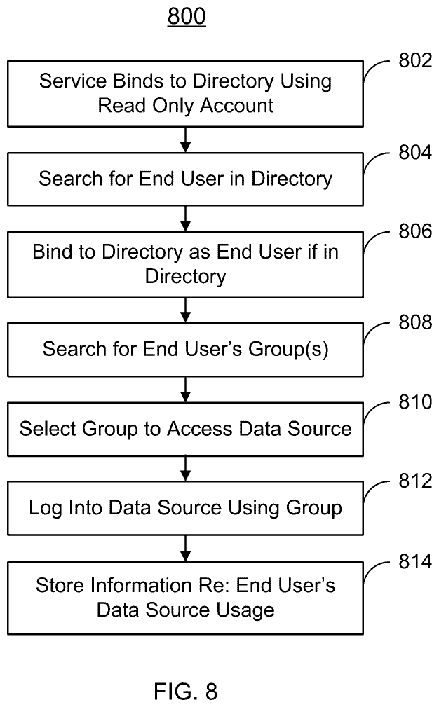

FIG. 8 is a flow chart depicting an exemplary embodiment of method 800 for performing federated identity management for a client for a data source using an LDAP directory. Method 800 is described in the context of system 300. However, method 800 may be used in connection with other systems including but not limited to systems 100 and 200. For simplicity, certain steps of method 800 are depicted. Method 800 may include other and/or additional steps and substeps. Further, the steps of method 800 may be performed in another order including performing portions or all of some steps in parallel. In some embodiments, method 800 may be considered to be used in implementing 506 of method 500 and/or 704, 706 and/or 708 of method 700. For the purposes of explanation of method 800, service 314-6 is considered to provide federated identity management via LDAP. Method 800 is considered to commence after sidecar 310 is provided with a specialized account for LDAP directory 330-2. The specialized account allows sidecar 310 to obtain information from LDAP directory 330-2 that is not available to a typical end user, such as the identification of end users and the groups to which end users belong. In some embodiments, the account is a read only account for sidecar 310.

Service 314-6 binds to the LDAP directory using the read only account at 802. This may occur at some time before receipt of the end user's credentials and the request to access a data source using federated identity management. The binding of service 314-6 with the LDAP directory allows service 314-6 to provide federated identity management services in some embodiments.

A communication requesting access to data source(s) 302 and/or 304 is received at dispatcher 312 and provided to service 314-6 in a manner analogous to 502 and 504 of method 500. The communication includes the end user's LDAP credentials. Thus, the end user's LDAP credentials are received at service 314-6. After receiving the end user's LDAP credentials, service 314-6 may search for the end user in the LDAP directory using the read only account, at 804. Searching LDAP directory 330-2 allows service 314-6 to determine whether the user exists in LDAP directory 330-2. If not, sidecar 310 may prevent access to the desired data source(s). If, however, the end user is found at 804, then service 314-6 binds to the LDAP directory as a proxy for the end user, at 806.

Service 314-6 may then request a search for the groups to which the end user belongs, at 808. This is facilitated by the read only account for sidecar 310. Thus, service 314-6 may determine the groups to which the end user belongs as well as the privileges and limitations on each group. A group to be used for accessing the data source(s) 302 and/or 304 is selected at 810. In some embodiments, service 314-6 ranks groups based upon their privileges. A group having more privileges (e.g. able to access more data sources or more information on a particular data source) is ranked higher. In some embodiments, service 314-6 selects the highest ranked group for the end user. In some embodiments, service 314-6 selects the lowest ranked group. In some embodiments, the user is allowed to select the group. In other embodiments, another selection mechanism may be used.

The desired data source(s) are accessed using the selected group, at 812. Thus, the end user may access data and/or applications based upon their membership in the selected group. Information related to the end user's activities is logged by sidecar 310, at 814. For example, services 314-6 may directly log the end user activities or may utilize another service, such as query analysis, to do so.

Using method 800, an end user may be able to access the desired data sources via federated identity management performed through an LDAP directory. The benefits of federated identity management may thus be achieved. In addition, the end user's actions may be logged. Thus, visibility into the activities of individual end users may be obtained.

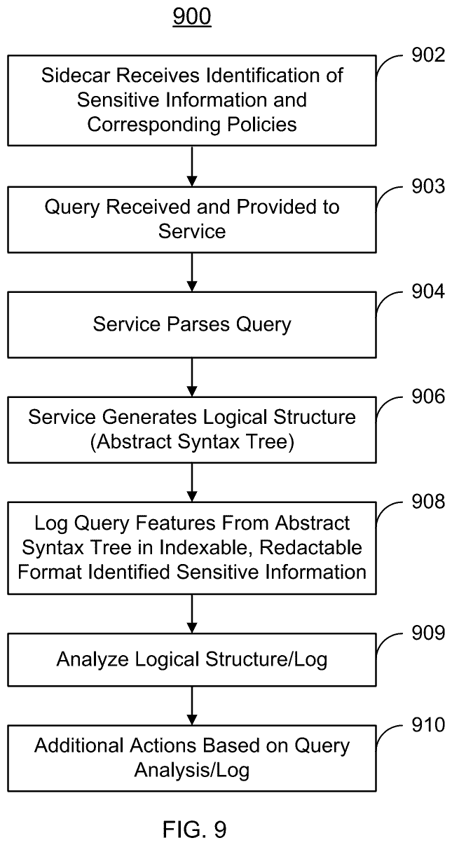

FIG. 9 is a flow chart depicting an exemplary embodiment of method 900 for analyzing and logging information related to queries of a data source. Method 900 is described in the context of system 100. However, method 900 may be used in connection with other systems including but not limited to systems 200 and 300. For simplicity, certain steps of method 900 are depicted. Method 900 may include other and/or additional steps and substeps. Further, the steps of method 900 may be performed in another order including performing portions or all of some steps in parallel. In some embodiments, method 900 may be considered to be used in implementing 506 of method 500. For the purposes of explanation of method 900, service 114-1 is considered to provide query analysis and logging. Thus, a client, such as client 106-1 may be considered to be authenticated for data source(s) 102 and/or 104 and to perform a query for data on one or both of data sources 102 and 104. In some embodiments, the query may be an SQL query.

Sidecar 110 receives an identification of information of interest in the data source(s) 102 and/or 104, at 902. Also at 902, policies related to the sensitive information are also received. Reception of this information at 902 may be decoupled from receiving queries and analyzing queries for the remainder of method 900. For example, owner(s) of data source(s) 102 and/or 104 may indicate to sidecar 110 which tables, columns/rows in the tables, and/or entries in the tables include information that is of interest or sensitive. For example, tables including customer names, social security numbers (SSNs) and/or credit card numbers (ccns) may be identified at 902. Columns within the tables indicating the SSN, ccn and customer name, and/or individual entries such as a particular customer's name, may also be identified at 902. This identification provides to sidecar 110 information which is desired to be logged and/or otherwise managed. Further, policies related to this information are provided at 902. Whether any logging is to be performed or limited is provided to sidecar at 902. For example, any user access of customer tables may be desired to be logged. The policies indicate that queries including such accesses are to be logged. Whether data such as SSNs generated by a query of the customer table should be redacted for the log may also be indicated in the policies.

Sidecar 110 receives a query from a client at dispatcher 112 and provides the query to service 114-1, at 903. The query may also be sent from dispatcher 112 to the appropriate data source(s) as part of 903. Process 903 is analogous to 502 and 504 of method 500. Thus, the query is received at service 114-1. Service 114-1 parses a query provided by a client 106, at 904. For example, a client 106-1 may provide a query for data source 102 to sidecar 110. Dispatcher 112 receives the query and provides the query both to data source 102 and to service 114-1. Service 114-1 parses the query to determine which operations are requested and on what portions of data source 102. Service 114-1 thus emits a logical structure describing the query and based on the parsing, at 906. In some embodiments, the logical structure is an abstract syntax tree corresponding to the query. Each node in the tree may represent a table being searched, operation in the query, as well as information about the operation. For example, a node may indicate a join operation or a search operation and be annotated with limitations on the operation.

The query is logged, at 908. The log may include the end user/client 106-1 that provided the query as well as the query string. In addition, the features extracted from the abstract syntax tree may be logged in a manner that is indexable or otherwise more accessible to analytics. Further, the log may be configured to be human readable. In some embodiments, a JSON log may be used. For example, a list of the operations and tables accessed in the query may be included in the log. Sensitive information such as SSN may be redacted from the log in accordance with the identification of sensitive information and policies relating to sensitive information received at 902. Thus, a placeholder may be provided in the log in lieu of the actual sensitive information accessed by the query. In some embodiments, the logical structure and/or log are analyzed at 909. This process may include analyzing the abstract syntax tree and/or information in the log.

Based on the query analysis and/or log, additional action may be taken by sidecar 110, at 910. For example, a query rewriting service that is part of service 114-1 or a separate service may be employed if it is determined in 909 that the log generated in 908 indicates that the query may adversely affect performance. For example, limits may be placed on a query, clauses such as an “OR” clause and/or a tautology identified and/or removed. As a result, queries that result in too many rows being returned may be rewritten to reduce the number of rows. If the log or other portion of the query analysis indicates that the query may represent an attack, then access to the data source may be denied at 910. For example, the analysis at 909 of the logical structure and log may indicate that the query includes wildcards or tautologies in users' names. The corresponding routine may terminate the connection to the client from which the query originated. If the query has been passed on to data source 102, then the query may be canceled at 910. Unwanted exfiltration of sensitive information may thus be prevented. If the query analysis indicates that a similar query was recently serviced, then some or all of the information for the similar query that already exists in a cache may be used to service the query. If the query can be completely serviced by information in the cache, then the query may be recalled from/canceled before or during servicing by data source 102. Thus, various actions may be taken based upon the analysis of the query by service 114-1.

For example, suppose as mentioned above that data source 102 includes a customer table of customer information having columns of customer names, customer SSNs, customer ccns, tokenized ccns (e.g. ccn encrypted with FPE or represented by a token), and customer identifiers (CIDs). Suppose data source 102 also includes an order table including a table of customer orders. The table includes a column of order customer identifiers (OCIDs) and multiple columns of orders for each customer identifier. In each order column, the item prices for the order are indicated. The order customer identifier for the order table is the same as the customer identifier in the customer table for data source 102. Query analysis and logging may be performed by service 114-1.

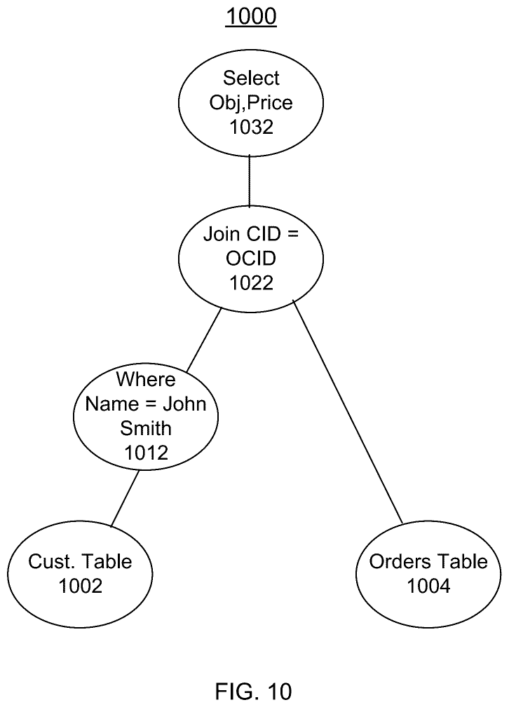

At 902, service 114-1 is informed that the customer table and the columns of customer names, customer SSNs and (tokenized) customer ccns are sensitive information for which activity is desired to be logged. Also at 902, service 114-1 is informed that customer names and SSNs are to be redacted from the log. A query of data source 102 may be provided to dispatcher 112 by end user of client 106-1. Dispatcher 112 forwards the query to data source 102 and to service 114-1. The query is: select object price from customer table join order table on customer identifier=order customer identifier and where name=John Smith (where John is a name of a particular customer). Thus, the query determines the price of objects ordered by John Smith. FIG. 10 depicts the corresponding abstract syntax tree 1000 generated from the query at 906. The abstract syntax tree has been annotated for clarity. Nodes 1002, 1004, 1012, 1022 and 1032 and lines connecting nodes 1002, 1004, 1012, 1022 and 1032 represent the query. From abstract syntax tree 1002, a log is generated by service 114-1 at 908. The log indicates that the customer table has been accessed by end user of client 106-1, that column customer name was read, and the where name=[redacted] was accessed. This information may be provided in a format that is readily usable by analytics, indexable and/or searchable. In some embodiments, the string forming the query may also be provided in the log. However, because they were not identified as being of interest, the order table, CID, OCID and object price are not included in the indexable portion of the log.

Thus, using method 900, performance of system 100 may be improved. Method 900 may facilitate analysis of queries performed, aid in response to attacks, and/or improve performance of the data source. Because dispatcher 112 is data agnostic and may be a transport layer component, this may be achieved without requiring changes to data sources 102 and 104 while maintaining stability of the data sources 102 and 104. Thus, performance and security for system 100 may be enhanced.

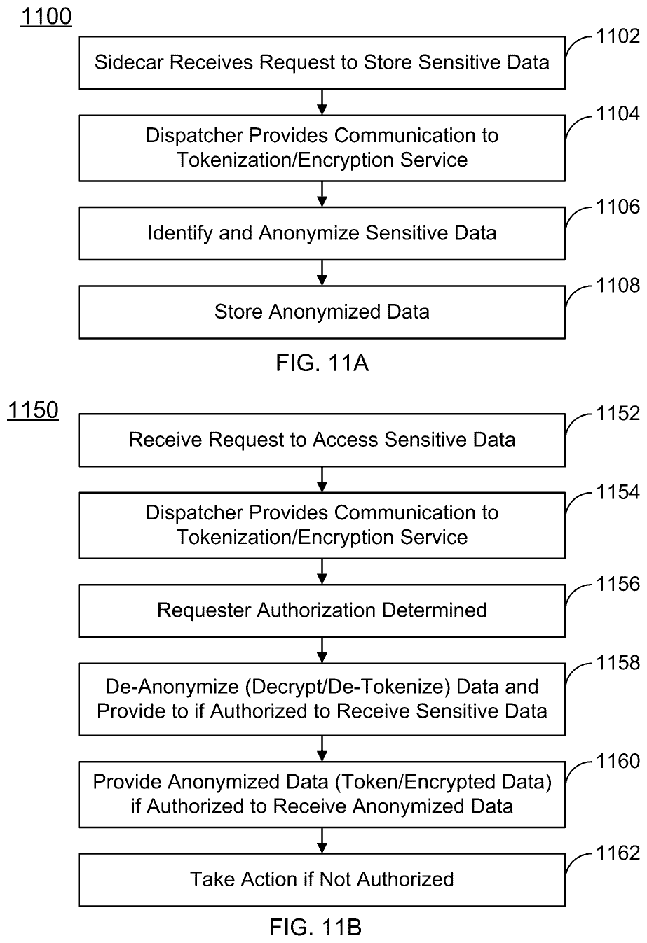

FIGS. 11A and 11B are flow charts depicting exemplary embodiments of methods for utilizing tokenization and/or encryption of sensitive data. FIG. 11A is a flow chart depicting an exemplary embodiment of method 1100 for using tokenization and/or encryption for storing data at a data source. Method 1100 is described in the context of system 300. However, method 1100 may be used in connection with other systems including but not limited to systems 100 and 200. For simplicity, certain steps of method 1100 are depicted. Method 1100 may include other and/or additional steps and substeps. Further, the steps of method 1100 may be performed in another order including performing portions or all of some steps in parallel. In some embodiments, method 1100 may be considered to be used in implementing 506 of method 500.

Method 1100 may be considered to start after system 300 receives policies indicating how sensitive data are to be treated. For example, policies indicating what data are sensitive (e.g. which tables/entries include sensitive data), what clients are allowed to have access to the sensitive data, for what purposes client(s) are allowed to have access to the sensitive data, how the sensitive data are to be anonymized (e.g. tokenized and/or encrypted), and/or other information desired by controller of data sources 302 and/or 304 have already been received by sidecar 310 and provided to the appropriate service(s). Although described in the context of access to a single data source, in some embodiments, method 1100 may be used for multiple data sources. In some embodiments, the same service fulfills request to store sensitive data and requests to obtain sensitive data. In some embodiments, some service(s) may service requests to store data/tokenize data while other service(s) are used obtain the tokenized data. However, such services communicate in order to service at least some of the requests. In some embodiments, the same service may utilize different types of anonymization (e.g. tokenization and encryption). In other embodiments, different services may be used for different types of anonymization. For example, one service may tokenize data while another service encrypts data. Method 1100 is described as being used in connection with method 1150. In other embodiments, method 1100 may be used with a different method for accessing encrypted/tokenized data.

A request from a client to store sensitive data at a data source is received by a sidecar, at 1102. The dispatcher, which is data agnostic, forwards the request to an encryption/tokenization service for anonymization of the sensitive data desired to be stored, at 1104. Based on the policies provided and/or capabilities of the services, the sensitive data is anonymized, at 1106. In some embodiments, the data desired to be stored includes sensitive data desired to be anonymized as well as data that need not by anonymized. In such embodiments, 1106 also includes identifying the sensitive data to be anonymized. In some embodiments, anonymizing data includes encrypting and/or tokenizing the data. For some sensitive data, encryption such as format preserving encryption (FPE) may be used. For example, ccns and SSNs may be encrypted using FPE such that the encrypted data has the same number of digits as the ccn and SSN (i.e. such that the format is preserved) but does not have intrinsic meaning. The alphanumeric string having nine members may replace an SSN. Other types of encryption, tokenization, and/or data masking may also be used at 1106. Thus, at 1106 the sensitive data is anonymized. Because policies may be used to determine how and what data are encrypted/tokenized, 1106 is performed on an attribute level. For example, the ccn of a user may be encrypted by FPE, but the SSN of the same user may be replaced by a token based on the policies used by the encryption/tokenization service. The anonymized data is stored in the data source, at 1108. Thus, the anonymized data may be retained in place of the actual sensitive data. In some embodiments, the sensitive data may also be stored, for example in a secure data vault, which may require enhanced authentication to access. Thus, using method 1100, sensitive data may be tokenized and/or encrypted and stored using a data agnostic dispatcher.

FIG. 11B is a flow chart depicting an exemplary embodiment of method 1150 for accessing tokenized and/or encrypted data from a data source. Method 1150 is described in the context of system 300. However, method 1150 may be used in connection with other systems including but not limited to systems 100 and 200. For simplicity, certain steps of method 1150 are depicted. Method 1150 may include other and/or additional steps and substeps. Further, the steps of method 1150 may be performed in another order including performing portions or all of some steps in parallel. In some embodiments, method 1150 may be considered to be used in implementing 506 of method 500. Method 1150 may be considered to start after system 300 receives policies indicating how sensitive data are to be treated. For example, policies indicating what data are sensitive (e.g. which tables/entries include sensitive data), what clients are allowed to have access to the sensitive data, for what purposes client(s) are allowed to have access to the sensitive data, how the sensitive data are to be anonymized (e.g. tokenized and/or encrypted), and/or other information desired by controller of data sources 302 and/or 304 have already been received by sidecar 310 and provided to the appropriate service(s). Although described in the context of access to a single data source, in some embodiments, method 1150 may be used for multiple data sources. In some embodiments, the same service fulfills request to store sensitive data and requests to obtain sensitive data. In some embodiments, some service(s) may service requests to store data/tokenize data while other service(s) are used obtain the tokenized data. However, such services communicate in order to service at least some of the requests. In some embodiments, the same service may utilize different types of anonymization (e.g. tokenization and encryption). In other embodiments, different services may be used for different types of anonymization. For example, one service may tokenize data while another service encrypts data. Method 1150 is described as being used in connection with method 1100. In other embodiments, method 1150 may be used with a different method for anonymizing data.

A request for the sensitive data stored at data source is received by the sidecar, at 1152. The request may come from the same client that stored the data or a different client. Because request(s) for data may be independent of storage, 1152 through 1162 may be decoupled from 1102 through 1108. For example, the request may be received at 1152 at a different time, or may not be received. Thus, methods 1100 and 1150 are separately described. The dispatcher provides the request to access sensitive data to encryption/tokenization service, at 1154. The request may also be forwarded to the data source storing the anonymized data.

The encryption/tokenization service determines what type of authorization the requestor possesses, at 1156. The requester may only be authorized to receive the anonymized (e.g. tokenized/encrypted) data. For example, the requesting client might be a computer system of data scientist associated with system 300. The data scientist/client may be allowed to track use of a credit card number, but not be authorized to know the actual credit card number. The requester may be authorized to receive the original, sensitive data. For example, the requesting client might be a merchant's payment system or the original user's computer systems, both of which may be authorized to receive the de-anonymized (e.g. unencrypted/de-tokenized) sensitive data. However, the requester may be unauthorized to receive either data. For example, the requesting client might be a malicious individual attempting to steal the sensitive data. At 1156, therefore, the encryption/tokenization service validates credentials for the requesting client. The encryption/tokenization service may use passwords, certificates, multifactor authentication, behavioral baselining through collector(s) and/or other mechanism(s). Thus, encryption/tokenization service may call another service to perform authentication at 1156.

If the requesting client is determined to be authorized to receive the sensitive data, then the anonymized data stored at the data source is retrieved, de-anonymized and provided to client, at 1158. For example, encryption/tokenization service may decrypt and/or detokenize the data that was stored in the data source. In another embodiment, instead of or in addition to decrypting/detokenizing the data, encryption/tokenization service may retrieve the original, sensitive data from a secure data vault (not shown in FIGS. 3 and 11A-11B). The sensitive data is then sent to the authorized requester at 1158.

If the requesting client is determined to be authorized to receive only the anonymized data, then this anonymized data are retrieved and sent to the requester, at 1160. For example, encryption/tokenization service may simply retrieve the anonymized data from the data source and forward this data to the requesting client. In some embodiments, a requester may be authorized to receive either or both of the sensitive data and the anonymized data. In such embodiments, 1158 and/or 1160 may include determining whether the requester has selected the anonymized/de-anonymized data and providing the anonymized/de-anonymized data. In some embodiments, both the anonymized and the de-anonymized data might be provided.

If, however, it is determined that the requester was not authorized, then other action is taken at 1162. For example, the routine may terminate the connection to client as described above, the communication may be recalled from the data source, the client may be blacklisted, managers of system 300 and/or owner of the sensitive data may be notified of the attempted breach and/or other action taken. For example, as discussed above, the corresponding routine may terminate the connection to the client from which the query originated. If the query has been passed on to the data source, then the query may be canceled at 1162. Unwanted exfiltration of sensitive information may thus be prevented.

Although described in the context of anonymized data at 1106 and storing the anonymized data at 1108, in another embodiment, step 1106 might be skipped and the sensitive data stored at 1108. However, in such embodiments, at 1158 no decryption is performed for the requester determined to be authorized to receive the sensitive data. Further, for requesters determined to be authorized to receive only encrypted/tokenized data, the data are encrypted/tokenized and then provided at 1160. Thus, methods 1100 and 1150 may be adapted to the case where sensitive data are stored.

For example, a request from client 306-1 to store sensitive data at data source 302 may be received by sidecar 310, at 1102. Dispatcher 312 forwards the request to encryption/tokenization service 314-2 for anonymization, at 1104. Based on the policies provided and/or capabilities of encryption/tokenization service 314-2, the sensitive data is identified and anonymized, at 1106. For example, encryption/tokenization service 314-2 may encrypt some sensitive data and tokenize other sensitive data. The anonymized data is stored in data source 302, at 1108.

A request from client 306-2 for the sensitive data stored at the data source is received by the sidecar 310, at 1152. Dispatcher 312 provides the request to access sensitive data to encryption/tokenization service 314-2, at 112. The request may also be forwarded by dispatcher 312 to data source 302.

Encryption/tokenization service 314-2 determines what type of authorization the requestor possesses, at 1156. Thus, encryption/tokenization service 314-2 validates credentials for the requesting client 306-2.

If the requesting client 306-2 is determined to be authorized to receive the sensitive data, then the anonymized data stored at data source 302 is retrieved, decrypted/detokenized and provided to client 306-2, at 1158. In another embodiment, instead of or in addition to decrypting/detokenizing the data, encryption/tokenization service 314-2 may retrieve the original, sensitive data from a secure data vault. The sensitive data is then sent to the authorized requester. If the requesting client 306-2 is determined to be authorized to receive only the anonymized data, then encryption/tokenization service 314-2 retrieves the anonymized data from data source 302 and forwards this data to the requesting client 306-2. If, however, it is determined that the requester was not authorized, then the routine may terminate the connection to client 306-2, the communication may be canceled or recalled from data source 302, client 306-2 may be blacklisted, managers of system 300 and/or owner of the sensitive data (e.g. user of client 306-1) may be notified of the attempted breach and/or other action taken.

Using methods 1100 and 1150 sensitive data may be more securely stored and retrieved. Instead of storing sensitive data, anonymized data may be stored at 1108. How and what data are anonymized may be determined on an attribute level, which improves flexibility of methods 1100 and 1150. This improves the ability of system 300 and methods 1100 and 1150 to protect sensitive data from being inappropriately accessed. Because these functions are provided via service(s) 314, the enhanced security may be provided for data source(s) 302 and/or 304 that do not otherwise support encrypted data. Stated differently, secure storage and encryption/tokenization of data may be performed in a data agnostic manner. Thus, methods 1100 and 1150 may provide additional security to such data sources without requiring changes to the code of data sources 302 and 304. Security may thus be improved in a simple, cost effective manner.

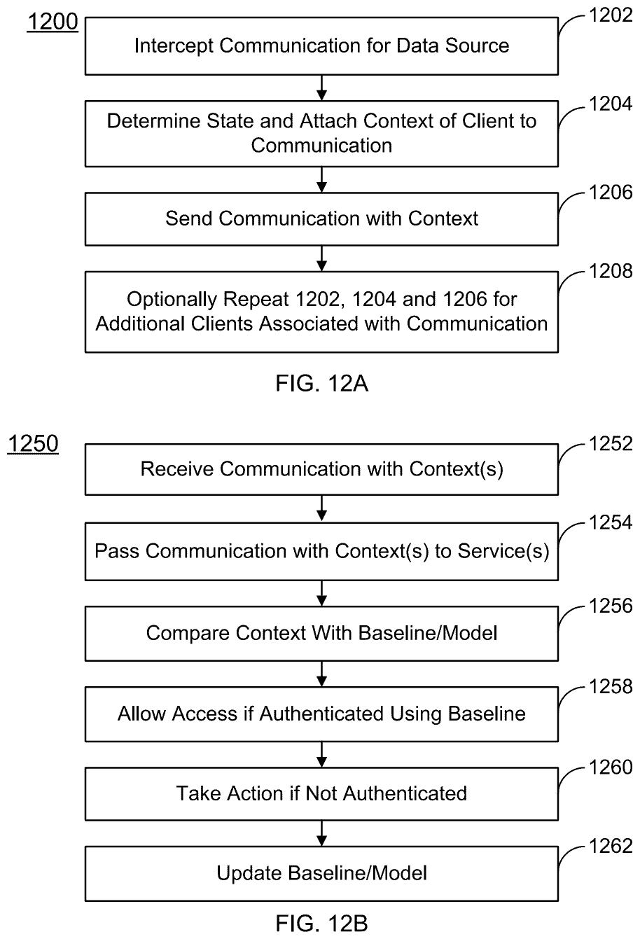

FIGS. 12A and 12B are flow charts depicting exemplary embodiments of methods for providing client information and for performing behavioral baselining for clients. FIG. 12A is a flow chart depicting an exemplary embodiment of method 1200 for providing client information and may be used as part of performing behavioral baselining for a client. Method 1200 is described in the context of system 300. However, method 1200 may be used in connection with other systems including but not limited to systems 100 and 200 that employ collectors such as collectors 320. For simplicity, certain steps of method 1200 are depicted. Method 1200 may include other and/or additional steps and substeps. Further, the steps of method 1200 may be performed in another order including performing portions or all of some steps in parallel. In some embodiments, method 1200 may be considered to be used in implementing 506 of method 500. Method 1200 is described in the context of clients 306-2 and 306-3, collectors 320-2 and 320-3, service 314-2 and data source 302. Thus, method 1200 commences after collectors 320 have been provided on one or more clients 306 utilizing data sources. However, in other embodiments, other clients, collectors, service(s) and/or other data sources may be used.

Communications for data source(s) to be issued by a client are intercepted, for example by a collector at the client, at 1202. In some embodiments, queries, method or API calls, commands or other messages may be intercepted before being provided from the client for transmission to the sidecar. In some embodiments, for example, a collector may attach itself to a client application and use Java Database Connectivity (JDBC) to intercept queries from the client of the data source(s). Thus, the collectors monitor the corresponding clients and intercept particular calls.

The state of the client issuing the communication is determined and attached to/associated with the intercepted communication, at 1204. For example, the type of call, the type of session/session identification, user identification for the session, the type of command (e.g. get, put, post, and delete commands), APIs, IP address, query attributes, method calls, order of queries, and/or application making the calls may be detected by the collector and attached to the communication at 1204. These attributes represent the context, or state, of the client (or client application) when issuing the communication. The collector attaches this context/state to the query or other communication being provided from the client. The communication and attached state are sent from the client, at 1206. In some embodiments, the attached state may be considered to be part of or included in the communication sent from the client.

In some embodiments, other clients may receive the communication from the sending client, perform other functions and then issue another communication. Thus, multiple clients may send and receive a communication before the communication is provided to the sidecar or data source. At each client that includes a collector and that receives the communication, any outgoing communication is intercepted as in 1202, the context for that client is determined and attached to the communication as in 1204 and the communication and state/context sent as in 1206, via 1208. If only a single client having a collector sends the communication to the sidecar, then 1208 may be omitted. If five clients having collectors send the communication in series, then the originating client performs 1202, 1204 and 1206. 1208 may be repeated four times for the four additional clients receiving and sending the communication. If five clients, only four of which have collectors, receive the communication in series, then 1208 may be repeated three times. Thus, multiple clients may be involved in providing a communication to the data source. Each of the clients having a collector can attach their state to the communication. Further, the states may be attached in the order in which the clients sent/received the communication. The last client sending the communication provides the communication to a sidecar, such as sidecar 310.

Thus, using method 1200, the context for a client can be provided to along with the communication. For clients providing multiple communications, the series of contexts provided with these communications may represent typical behavior for the client during interaction with the data source. Thus, the client(s) may send information relating to their state and/or behavior in addition to communications such as queries.

FIG. 12B is a flow chart depicting an exemplary embodiment of method 1250 for performing behavioral baselining for a client. Method 1250 is described in the context of system 300. However, method 1250 may be used in connection with other systems including but not limited to systems 100 and 200 that employ collectors such as collectors 320. For simplicity, certain steps of method 1250 are depicted. Method 1250 may include other and/or additional steps and substeps. Further, the steps of method 1250 may be performed in another order including performing portions or all of some steps in parallel. In some embodiments, method 1250 may be considered to be used in implementing 506 of method 500. Method 1250 is described in the context of clients 306-2 and 306-3, collectors 320-2 and 320-3, service 314-2 and data source 302. Thus, method 1250 commences after collectors 320 have been provided on one or more clients 306 utilizing data sources. However, in other embodiments, other clients, collectors, service(s) and/or other data sources may be used. Method 1250 may be performed in conjunction with method 1200 and so may receive communications and states/contexts provided via method 1200.

The communication and context(s) of the client(s) are received at the sidecar, at 1252. The sidecar thus receives the communication, which may include multiple queries or method calls, as well as the states of all clients having collectors which sent the communication along before reaching the sidecar. In some embodiments, the communication and attached context(s) are received at the dispatcher. In some embodiments, the communication and attached context sent by the client at 1206 or 1208 of method 1200 is received at the sidecar at 1252.

The context(s) are forwarded from the dispatcher to behavioral baselining service(s), at 1254. In some embodiments, the communications with which the context(s) are associated are also provided to the behavioral baselining service(s) at 1254. Also at 1254, the dispatcher may send the communication on to the desired data source(s). Thus, processing of the query or other calls in the communication may not be delayed by inspection of the context(s) of clients and other functions performed by behavioral baselining service(s). In other embodiments, the communication may be held at the dispatcher until behavioral baselining is completed. This may occur, for example, if the dispatcher is in step mode described above.

The state(s)/context(s) for the client(s) associated with the communication are compared with baseline(s) for client(s), at 1256. In some embodiments, the communication is also part of this comparison. For example, the particular query of the database provided by the client as well as the state of the client may be used for comparison with the baseline. In other embodiments, just the context(s) might be used. In some embodiments, a single context of a client associated with a single communication is compared to the baseline(s) at 1256. In other embodiments, multiple contexts that may be in a particular order of a client are compared to the baseline at 1256. For example, the behavioral baselining service may store the context received for each communication for each client having a collector. Frequently, a client issues multiple communications for a data source when utilizing the data source. A set of these contexts for a particular client represents the behavior of that client around the time the client interacts with the data source. The behavioral baselining service analyzes the behavior (series of contexts) of the client(s) providing the communication(s). In some embodiments, only the identities of the contexts are used. In some embodiments, the identities of the contexts as well as their order are used for comparison. In some embodiments, the behavioral baselining service compares the context(s) to the behavior based upon a model of the behavior (the series of states/contexts), such as a Hidden Markov Model. Thus, in 1256 the behavioral baselining service maintains a model of requesting client(s)' behavior and compares the context in the current communication to the behavior. In some embodiments, a single context may be compared to the baseline in some cases and behavior in others. For example, for a first communication received by the sidecar, that first communication may be compared to the baseline. As additional communications are received, these communications may be compared to the baseline at 1256. In other embodiments, a client might first be authenticated and granted access to a data source based on another method of authentication, such as MFA. Once the client sends additional communication(s) with additional context(s), these communication(s) and context(s) may be used to compare the behavior for the client with the baseline. In some embodiments, the initial communication and authentication may be considered part of the behavior. In other embodiments, the initial communication and authentication may be considered separately from subsequent communication(s) and state(s).

If the context(s) for the current communication(s) sufficiently match the behavior, then the requesting client(s) are allowed access to the data source, at 1258. Thus, the data source is allowed to service the communication(s) provided by the client(s). If it is determined in 1256 that the context does not sufficiently match the behavior, then the desired action is taken, at 1260. In some embodiments, the action taken may depend upon the mismatch determined in 1256 or on other factors. For example, the client(s) initiating the communication(s) may not be allowed to access the data source. In such cases, the dispatcher may be informed and the corresponding routine used to terminate the connection to client(s). If the communication had already been forwarded to the data source(s), then the communication may be recalled from the data source(s). If the client had previously been authenticated, then the authentication may be revoked. In such embodiments, the dispatcher may be informed the client is unauthorized and the corresponding routine used to terminate the connection to client(s). Communication(s) that had been forwarded to the data source(s) may also be recalled from the data source(s). If the mismatch is sufficiently great or occurs greater than a threshold number of times, or at least a particular number of times in a row, then the client(s) may be blacklisted. In some embodiments, a secondary mechanism of authentication, such as MFA, may be invoked at 1260. Thus, access to the data source(s) may be determined at least in part based upon behavior of the requesting client(s). These and/or other actions may be taken at 1260.

The model/baseline may be updated, at 1262. For example, if it is determined that the context sufficiently matches the behavior at 1258, then the model/baseline may be updated with the context in the communication from client(s). If the context is considered inconsistent with the baseline, then the model/baseline may be updated with this information.

For example, suppose collector 320-2 in client 306-2 intercepts a communication including a query of data source 302 at 1202. The context of client 306-2 is determined by collector 320-2 and attached to the query. Client 306-2 then provides the communication and context to sidecar 310. Because client 306-2 provides the communication to sidecar 310 without providing the communication to another client 306, 1208 is skipped. Dispatcher 312 receives the communication at 1252 and provides the communication and context to behavioral baselining service 314-2 at 1254. The communication is also passed to data source 302 at 1254. Behavioral baselining service 314-2 compares the context received at 1254 to the baseline for client 306-2 at 1256. If the context received is consistent with the baseline, then access is allowed to data source 302, at 1258. Otherwise, access may be denied, for example the connection terminated, at 1260. Additional actions may also be taken at 1260 such as blacklisting client 306-2. The baseline may also be updated at 1262.

In some cases, multiple applications in multiple clients may pass a communication before the communication is sent to a data source. For example, this may occur where microservices are employed, as discussed above. For example, suppose collector 320-2 in client 306-2 intercepts the communication including a query of data source 302 at 1202. The state of client 306-2 is determined by collector 320-2 and attached to the query. Client 306-2 then provides the communication and state to client 306-3. In some cases, client 306-3 may add another query to the communication or otherwise modify the communication. Collector 320-3 in client 306-3 intercepts the communication, attaches the state of client 306-3 and provides the communication to sidecar 310 at 1208. Thus, the communication now includes the states of clients 306-2 and 306-3. If client 306-2 or 306-2 had passed the communication to client 306-4, which does not include a collector, then 1208 would be skipped for client 306-4 because no collector is present to determine and attach the state of client 306-4 to the communication. Dispatcher 312 receives the communication at 1252 and provides the communication and states to behavioral baselining service 314-2 at 1254. The communication is also passed to data source 302 at 1254. Behavioral baselining service 314-2 compares the states received at 1254 to the baselines for clients 306-2 and 306-3 at 1256. If the states received are consistent with the baselines, then access is allowed to data source 302, at 1258. Otherwise, access may be denied, for example the connection terminated and the communication recalled from data source 302, at 1260. Additional actions may also be taken at 1260 such as blacklisting client 306-2 and/or 306-3. The baseline(s) may also be updated at 1262.

Using methods 1200 and 1250, security and performance for data sources may be improved. The context(s)/state(s) of client(s) in communications requesting access to data source(s) may be analyzed to determine whether the communication is consistent with previous behavior of client(s). If the state(s) of the client(s) are inconsistent with the baseline, then access to the data source(s) may be prevented and/or additional action taken. Methods 1200 and 1250 may also be extended to compare behavior (a series of states, for example for multiple queries) of clients to previous behavior and authenticate clients based upon their behavior. Thus, attacks from a client that has been hijacked may be detected and addressed. Further, collectors need not be present on all clients to enhance security. Instead, if a sufficiently high fraction of clients includes collectors, data sources may be protected in a manner akin to herd immunity. Methods 1200 and/or 1250 may be coupled with other methods, such as query analysis in method 900, authentication using method 400, tokenization in method 1100 and/or MFA in method 600 to further improve security.

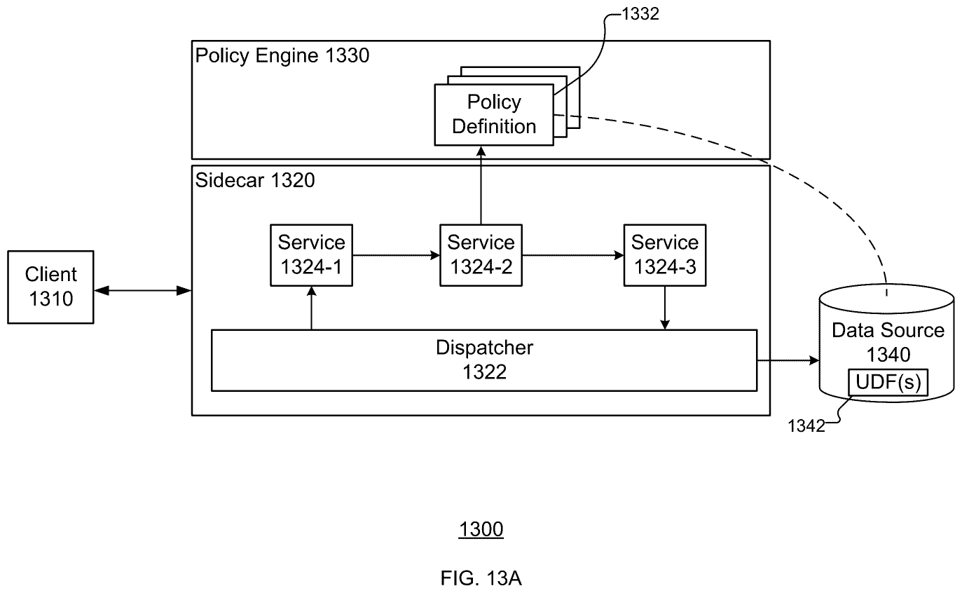

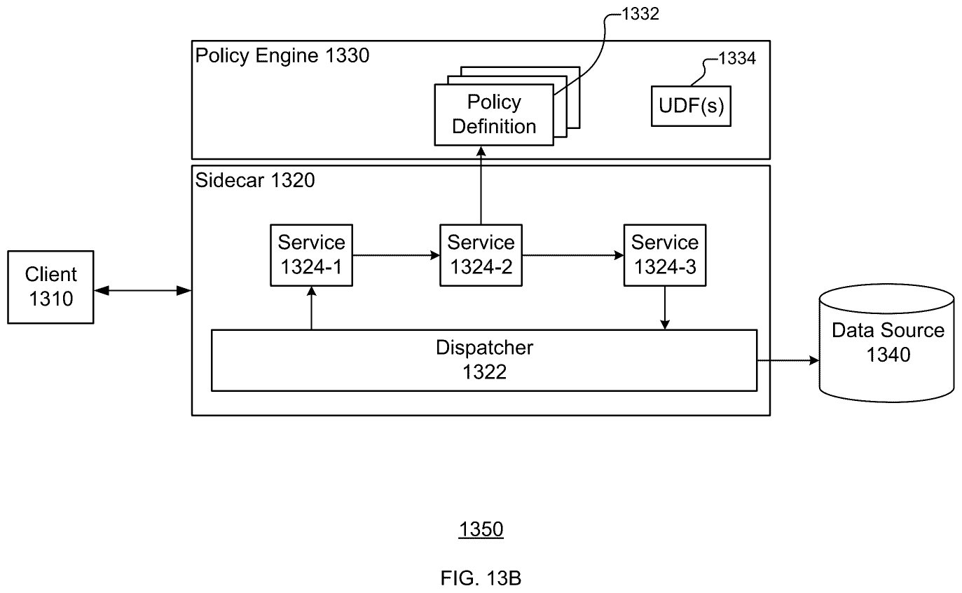

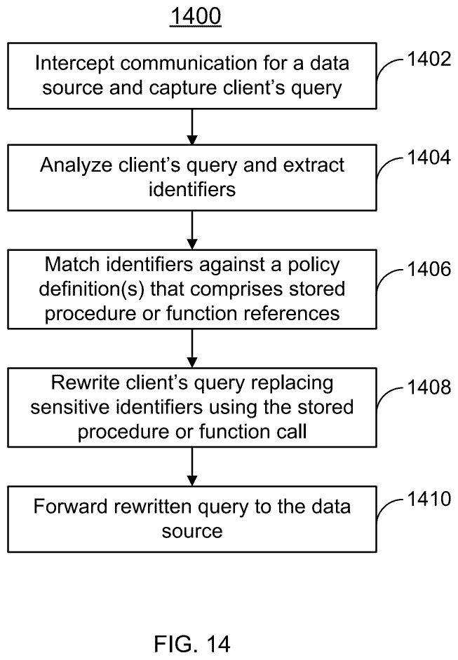

FIG. 13A is a block diagram of a system including a protective layer for a data source according to various embodiments. In some embodiments, system 1300 implements one or more of processes 1400-1600 of FIGS. 14-16. In the example shown, system 1300 comprises sidecar 1320 and data source 1340. Although a single data source 1340 is shown, system 1300 may comprise various numbers of data sources. The data sources may be databases, data stores, data vaults or other data repositories. Additionally, although a single sidecar (e.g., sidecar 1320) is shown, system 1300 may comprise a plurality of sidecars. In some embodiments, system 1300 additionally comprises policy engine 1330, which may be comprised in sidecar 1320 or a distinct module/service that can service queries from sidecar 1320.

According to various embodiments, sidecar 1320 mediates traffic to/from data source 1340. For example, a function of sidecar 1320 comprises serving as a proxy between client systems, such as client 1310, and data source 1340 to enable the client systems to interface with data source 1340. The client systems may include a microservice or microapplication. In the example shown, sidecar 130 comprises a dispatcher 1322 and one or more services, such as services 1324, 1324, and 1324-3. Although sidecar 1320 is shown as comprising a dispatcher 1322 and three services (e.g., services 1324, 1324, and 1324-3), various other or numbers of services or dispatchers may be implemented.

Although sidecar 1320 is shown as comprising dispatcher 1322 and services 1324, 1324, and 1324-3, according to various embodiments, the functionality of dispatcher 1322 and services 1324, 1324, and 1324-3 can be comprised/implemented by sidecar 1320, such as a single module, process or service (e.g., the functionality can be implemented by a single block of code, etc.). In some embodiments, dispatcher 1322 is an OSI Level 4 dispatcher that is platform agnostic, and the service(s) implemented by sidecar 1320 (e.g., services 1324, 1324, and 1324-3) is an OSI layer 7 service.

In response to client 1310 sending a communication (e.g., a query) to data source 1340, sidecar 1320 obtains the communication. For example, dispatcher 1322 intercept the communication and invokes the analysis and/or processing of the query. Dispatcher 1322 may extract the query from the intercepted communication and analyze the query (e.g., to invoke a service to process/analyze the query). Dispatcher 1322 may be agnostic to a type of data source to which the query is to be communicated, and may be configured to extract and analyze queries for a plurality of different types of data sources, etc.

According to various embodiments, in response to obtaining (e.g., intercepting) a communication and determining a query based on the communication, sidecar 1320 determines whether one or more policies are to be enforced in connection with processing the query. Sidecar 1320 may determine whether the one or more policies are to be enforced based on a query context. The query context can include identifiers pertaining to the query or other query contextual data, such as an account or user (e.g., a user identifier) associated with the query, a particular data source to which the query is destined, an IP address associated with the client (or other system from which the query is received or originated), a single sign on (SSO) group membership, etc. Examples of identifiers include column names, row names, table names, etc. For example, sidecar 1320 matches the query context against one or more policies (e.g., predefined policies stored in a policy library). In response to determining that sidecar 1320 determines that one or more policies are to be enforced in connection with processing the query, sidecar 1320 obtains the corresponding policy definition(s) (e.g., based on querying policy engine 1330, etc.), and causes the policy(ies) to be enforced. Causing the policy(ies) to be enforced includes determining whether a policy (e.g., the corresponding policy definition) indicates that a UDF is to be implemented in connection with enforcement of the policy during processing of the query. The policy definition may comprise a UDF identifier for one or more UDFs stored in a UDF library such as UDF library 1342. As an example, the UDF library 1342 is stored at the data source 1340 for data source 1340 to locally apply (e.g., locally execute) the UDF(s) while processing a query to obtain a query response. In some embodiments, in response to determining that enforcement of the policy includes applying a UDF, sidecar 1320 modifies (e.g., rewrites) the query in a manner that indicates to data source 1340 that the UDF is to be invoked (e.g., locally executed) in connection with processing the query.

According to various embodiments, a UDF comprises a stored procedures or function (or a function reference). The UDF (e.g. a procedure) may be created by a customer (e.g. a database engineer or other entity) and stored in data source 1340, such as in UDF library 1342. The policy (policy definition 1332 shown) determines the UDF to be applied in connection with enforcement of the policy, and sidecar 1320 causes the procedures or functionality of the UDF to be applied in connection with processing the query in accordance with the policy. For example, a query may be provided from the client 1310 to the sidecar 1320. The dispatcher 1322 of sidecar 1320 receives the query and calls the appropriate service(s).

In the embodiment shown, service 1324-1 analyzes the query and extracts identifiers such as the column and table names. In some embodiments, the analyzing the query includes parsing the query and generating a corresponding abstract syntax tree (AST). Service 1324-1 extracts the identifiers or other query context, such as based on the AST for the query. In response to extracting the identifiers or other query context, sidecar 1320 uses service 1324-2 to determine one or more policies to be enforced with respect to the query. For example, service 1324-2 determines the one or more policies to be enforced based at least in part on the identifiers or other query context. Service 1324-2 can obtain the policy(ies) to be enforced (e.g., service 1324-2 fetches the applicable policy definition 1332 for those policies that are to be enforced). For example, service 1324-2 can query a policy engine 1330 for the applicable policy definition(s). In some embodiments, service 1324-2 determines the one or more policies to be enforced based at least in part on checking (e.g., matching) the query (e.g., the identifiers or other query context) against the policy definition(s). Service 1324-2 can associate sensitive query identifiers to a stored procedure or function call, such as a UDF identified by the policy definition.

According to various embodiments, a policy (e.g., a corresponding policy definition) can indicate that a UDF is to be invoked. The policy may include an identifier of the UDF(s) to be applied in connection with enforcing the policy, and/or an indication of a manner in which the UDF is to be applied such as an indication of a type of data for which the UDF is to be applied, etc.

System 1300 (e.g., service 1324-3) causes the UDF to be applied during processing of the query. For example, service 1324-3 invokes the UDF, or instructs data source 1340 to apply (e.g., locally execute) the UDF when processing the query. In some embodiments, service 1324-3 modifies (e.g., rewrites) the query to invoke the UDF when the data source 1340 is processing the query. Accordingly, through the policy, the UDF is invoked. Thus, the desired action, such as rewriting or tokenizing sensitive data, may be performed. Other procedures may be implemented in an analogous manner. For example, service 1324-3 may rewrite the query such that sensitive data is obfuscated (e.g., such that data source 1340 processes the data to obfuscate the data when determining the query response). The rewriting of the query may include replacing identifiers to the corresponding stored procedure or function call (e.g., replacing or modifying the identifiers to include a call to the applicable UDF. In the example shown, service 1324-3 provides the rewritten query to the dispatcher 1322, which forwards the rewritten query to the data source 1340.

As an example, sidecar 1320 may receive a query “SELECT * FROM customers”. This query may correspond to a query in which the data for names, emails, and credit card number are selected/obtained. In response to determining that a policy is to be enforced with respect to this query and correspondingly determining a UDF to be applied with respect to the query, sidecar 1320 (e.g., service 1324-3) can rewrite the query as “SELECT name, email, mask(ccn) FROM customers.” For example, the applicable policy may indicate that a UDF for masking data may be applied with respect to the credit card number. As an illustrative example, “mask” may be the UDF name for a UDF that comprises a procedure/function for masking the applicable data. As another example of a rewritten query in accordance with a policy enforcement, sidecar 1320 may rewrite the query as “SELECT mask1(name), mask2(email), mask3(ccn) FROM customers.” Although the foregoing example provides the use of a UDF that masks data, various other types of UDFs or UDFs providing different functionality may be implemented. For example, a UDF to obfuscate the data differently from masking may be applied; a UDF to tokenize certain data may be applied, etc.

In some embodiments, sidecar 1320 the sidecar may execute a “catalog query” on the data store (e.g., data source 1340) to determine the names and types of columns present in the table. For example, sidecar 1320 causes the data source to execute the “catalog query.” The execution of the “catalog” query enables sidecar 1320 to determine that the “*” in the query (e.g., which has been inserted into the query based on application of the UDF) actually refers to three columns: name, email, ccn. The sidecar 1320 may execute the “catalog query” in advance of sending the updated/modified query to the data source (e.g., the input communication for obtaining data responsive to the query received by sidecar 1320). For example, the sidecar 1320 executes the catalog query in advance in order to determine the manner for properly applying the applicable UDF. In other implementations, sidecar 1320 executes the “catalog query” in conjunction or contemporaneous with execution of the updated/modified query.

The dispatcher, which is data agnostic, configures the query to the request the data source to implement an encryption/tokenization service for anonymization of the sensitive data desired to be stored, such as by indicating to the data source that the applicable UDF is to be applied with respect to the data. Based on the policies provided and/or capabilities of the services, the sensitive data is anonymized by the data source (e.g., via local execution of the UDF to anonymize the data). In some embodiments, the data desired to be stored or accessed includes sensitive data desired to be anonymized as well as data that need not by anonymized. In some embodiments, anonymizing data includes encrypting and/or tokenizing the data. For example, the data source may store a set of UDFs that respectively encrypt and/or tokenize applicable data. For some sensitive data, encryption such as format preserving encryption (FPE) may be used. For example, ccns (e.g., credit card numbers) and SSNs may be encrypted using FPE such that the encrypted data has the same number of digits as the ccn and SSN (e.g., such that the format is preserved) but does not have intrinsic meaning. The alphanumeric string having nine members may replace an SSN. Other types of encryption, tokenization, and/or data masking may also be implemented by various UDFs stored in a UDF library at the data source. Because policies may be used to determine how and what data are encrypted/tokenized, the UDF may be implemented (e.g., the sidecar may orchestrate the invocation/application of the UDF) on an attribute level. For example, the ccn of a user may be encrypted by FPE, but the SSN of the same user may be replaced by a token based on the policies used by the encryption/tokenization service. The anonymized data can be stored in the data source. Thus, the anonymized data may be retained in place of the actual sensitive data. In some embodiments, the sensitive data may also be stored, for example in a secure data vault, which may require enhanced authentication to access.

According to various embodiments, the UDF(s) is applied locally at the data source, such as in connection with the data source processing the query. The application of the UDF(s) locally at the data source may be more efficient and introduce less latency than other mechanisms for enforcing similar functionality. For example, if data to be manipulated or processed for determining a query response is on the order of a gigabyte, the manipulating of such large amounts of data introduces a high processing overhead associated with pulling the data from the data source and manipulating the data elsewhere such as locally at the sidecar.

FIG. 13B is a block diagram of a system including a protective layer for a data source according to various embodiments. In some embodiments, system 1350 implements one or more of processes 1400-1600 and/or 1800 of FIGS. 14-16 and 18. According to various embodiments, system 1350 is similar to system 1300, however, UDF library is not comprised in or executed by data source 1340. In the example shown, UDF library 1334 is comprised in policy engine 1330. However, UDF library 1334 may be stored elsewhere, such as locally at sidecar 1320 or in a remote repository accessible by sidecar 1320 and/or policy engine 1330. Additionally, or alternatively, UDF library 1334 may be comprised in data source 1340 (as shown in FIG. 13A), however, the UDF(s) comprised in UDF library 1334 can be accessed by sidecar 1320 or policy engine 1330 in connection with rewriting the query, such as in a manner that data source 1340 does not locally execute or call the UDF when processing the rewritten query.

According to various embodiments, system 1350 applies the UDF based on rewriting the query, such as to comprise the logic or functionality of the UDF. For example, sidecar 1320 uses service 1324-1 to analyze the query, as described in connection with system 1300. Sidecar 1320 uses service 1324-2 to obtain the policy to be enforced. In some embodiments, the obtaining the policy comprises obtaining one or more UDFs identified in the policy (e.g., one or more UDFs to be applied when enforcing the policy). For example, service 1324-2 can obtain a UDF definition or otherwise obtain the logic or functionality of the UDF.

In contrast to system 1300, system 1350 uses service 1324-3 to apply the UDF in a manner in which the UDF is not called (e.g., executed or invoked) by data source 1340. For example, system 1350 uses service 1324-3 to rewrite the query to comprise the logic or functionality of the UDF(s) to be applied in connection with enforcing the policy. The query may be rewritten in such a manner that when executed by the data source 1340, the logic/functionality is automatically executed by the data source 1340, such as without the data source 1340 locally calling the UDF (e.g., without invoking a locally stored UDF or otherwise obtaining an UDF to be applied when processing the query received from sidecar 1320).

According to various embodiments, the UDF(s) is applied locally at the sidecar source, such as in connection with the rewriting the query to comprise the logic or functionality of the UDF so the processing of the query by the data source includes applying the logic or functionality of the UDF without the data source specifically calling or invoking the UDF locally at the data source. The application of the UDF(s) locally at the data source may be more efficient and introduce less latency than other mechanisms for enforcing similar functionality. As an illustrative example, if a UDF to be applied a masking function in which a certain field/value is to be masked, the query is rewritten in such a manner that the sidecar 1320 (e.g., the rewritten query) asks the data source 1340 to return the response with the particular masking identified in the rewritten query (e.g., to replace the appropriate field/value with a predefined symbol identified in the rewritten query, etc.).

FIG. 14 is a flow diagram of a method for processing a query for data stored at a data source according to various embodiments. In some embodiments, process 1400 is implemented at least in part by system 1300 of FIG. 13A and/or system 1350 of FIG. 13B. Process 1400 may be implemented by a sidecar, such as a proxy between via which a system (e.g., a client system) interfaces with a data source.

At 1402, the system intercepts a communication for a data source and captures a client's query. The system obtains the client's query pertaining to data stored at a data store or for data to be stored at the data store. In some embodiments, the system uses a dispatcher to intercept the client's query.

At 1404, the system analyzes the client's query and extracts identifiers associated with the query. In response to intercepting the communication and obtaining (e.g., extracting the client's query), the dispatcher provides the client query to a first service comprised in the sidecar. The first service analyzes the client query and extracts information pertaining to the query, such as a set of identifiers for data pertaining to the query. Examples of identifiers include column names, row names, table names, etc. Additionally, the first service may determine further query contextual data, such as an account or user (e.g., a user identifier) associated with the query, a particular data source to which the query is destined, etc.

At 1406, the system matches identifiers against a policy definition(s) that comprises stored procedure or function references. In some embodiments, the system uses a second service to determine a policy to be enforced in connection with processing the client query. The second service can determine one or more policies to be enforced based at least in part on the identifiers extracted from, or associated with, the client query.

According to various embodiments, the second service determines the one or more policy to be enforced based at least in part on querying a policy engine. The prediction engine may be a module, process, or service running in the sidecar, or as a distinct module, process, or service that is external to the sidecar. The querying of the policy engine may include a query for the policy engine to identify the one or more policies applicable to the query context (e.g., the extracted identifiers, the user or account associated with the client query, the data source pertaining to the client query, etc.). Alternatively, the second service determines the applicable policy(ies) and queries the policy engine for information pertaining to the policy(ies). For example, the second service queries the policy engine to provide the policy requirements to be enforced, such as to identify one or more UDFs referenced by the policy(ies).

At 1408, the system rewrites the client's query based at least in part on replacing sensitive identifiers using the stored procedure or function call. In some embodiments, the system uses a third service to generate an instruction to the data source to apply (e.g., to locally execute) the one or more UDFs at the data source in connection with processing the query. As an example, the third service modifies (e.g., rewrites) the query to include an indication that the one or more UDFs are to be applied in connection with the data source processing the query to obtain a response.

At 1410, the system forwards the rewritten query to the data source. The data source processes the rewritten query, including applying one or more UDFs in connection with processing the query and determining (e.g., generating) a response. For example, the data source extracts the indication of the one or more UDFs to be applied for the processing of the query. In some embodiments, the applying of the one or more UDFs comprises locally executing the one or more UDFs at the data source, such as in connection with transforming, masking, obfuscating, filtering, or enrichment of data pertaining to the query to obtain the query response.

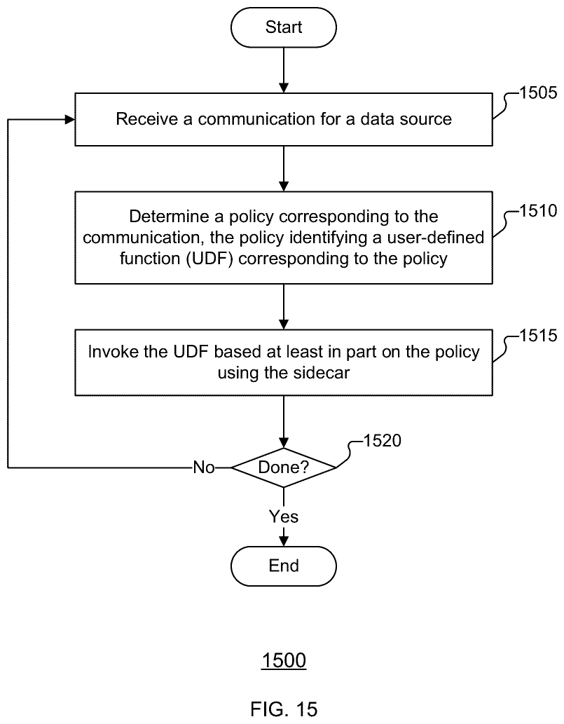

FIG. 15 is a flow diagram of a method for processing a query for data stored at a data source according to various embodiments. In some embodiments, process 1500 is implemented at least in part by system 1300 of FIG. 13A and/or system 1350 of FIG. 13B. Process 1500 may be implemented by a sidecar, such as a proxy between via which a system (e.g., a client system) interfaces with a data source.

At 1505, the system receives a communication for a data source. The communication may be a query or a request for a query to be processed at a data store (e.g., a request to obtain data from a data store. In some embodiments, the sidecar receives (e.g., intercepts) a query pertaining to data stored in a data store. The query can be sent by another system (e.g., a client system) or service. The sidecar can serve/function as a proxy between the other system and the data source. The sidecar can invoke one or more services or processes to process the query.

At 1510, the system determines a policy corresponding to the communication. The policy identifies a UDF corresponding to the policy. For example, the policy indicates a UDF to be applied in connection with enforcing the policy. In some embodiments, the sidecar uses a policy engine to determine one or more policies to be enforced with respect to processing the query. The system can determine the one or more policies to be enforced based at least in part on a context for the query. For example, the system determines the one or more policies to be enforced based at least in part on one or more of: of (i) the communication, (ii) a system from which the communication is received, (iii) a user or account associated with the system, and (iv) the data source. The policy engine may store (or have access to) a policy library comprising various policies to be applied in different contexts.

In some embodiments, a policy may indicate that one or more UDFs are to be applied in connection with processing a query (e.g., a query for which the policy is to be enforced). The UDFs may be stored at the data store for local execution by the data store. In response to determining that the policy to be enforced indicates that a UDF(s) is to be applied, the system (e.g., the sidecar) can provide an indication to the data store that the UDF(s) is to be applied in connection with processing a corresponding query. For example, the sidecar modifies (e.g., rewrites) the query to indicate the UDF to be applied by the data source. As another example, the sidecar forwards the query and corresponding other communication indicating that the UDF(s) are to be applied in connection with processing the query.

According to various embodiments, in response to determining that a plurality of UDFs are to be applied at the data store, the system (e.g., the sidecar, or a policy engine used by the sidecar) determines whether the plurality of UDFs are expected to introduce a conflict. In response to determining that the plurality of UDFs are expected to introduce a conflict, the system determines a conflict resolution (e.g., a manner for resolving the expected conflict) and causes the conflict resolution to be implemented. In some embodiments, implementing the conflict resolution includes updating (e.g., rewriting) the query based at least in part on the conflict resolution. For example, the system updates the query to comprise/indicate the UDFs to be applied at the data source in a manner in which the conflict resolution is implemented.

The system can determine the conflict resolution based at least in part on a set of predefined rules. The system may use the set of predefined rules to determine a priority in which the UDFs are to be applied. In response to determining the priority in which the UDFs are to be applied, the system can modify a manner or extent to which the UDFs are to be applied, such as to cause a primary UDF (e.g., a UDF having a highest priority) to be implemented normally and to modify the manner in which the subordinate UDF(s) are to be applied.

At 1515, the system causes the UDF to be invoked based at least in part on the policy. In some embodiments, the system invokes the UDF (e.g., causes the data source to invoke the UDF) based at least in part on the sidecar modifying (e.g., rewriting) the query to indicate the UDF to be applied by the data source. For example, the system modifies the query (e.g., generates an input communication for the data source) to cause the data source to call or otherwise apply the UDF. The data source can locally apply the UDF in connection with executing the modified query (e.g., the input communication). In some embodiments, the sidecar forwards the query and corresponding other communication indicating that the UDF(s) are to be applied in connection with processing the query. By indicating to the data source, the UDF(s) to be applied in connection with processing the query, the system ensures that the UDFs are executed locally at the data source in connection with determining a response to the query.

According to various embodiments, the system causes the UDF to be invoked by modifying the query (e.g., configuring an updated query) to comprise the logic of the UDF to be applied in connection with processing the query.

At 1520, a determination is made as to whether process 1500 is complete. In some embodiments, process 1500 is determined to be complete in response to a determination that no further queries are to be processed, a response has been provided to the communication, an administrator indicates that process 1500 is to be paused or stopped, etc. In response to a determination that process 1500 is complete, process 1500 ends. In response to a determination that process 1500 is not complete, process 1500 returns to 1505.

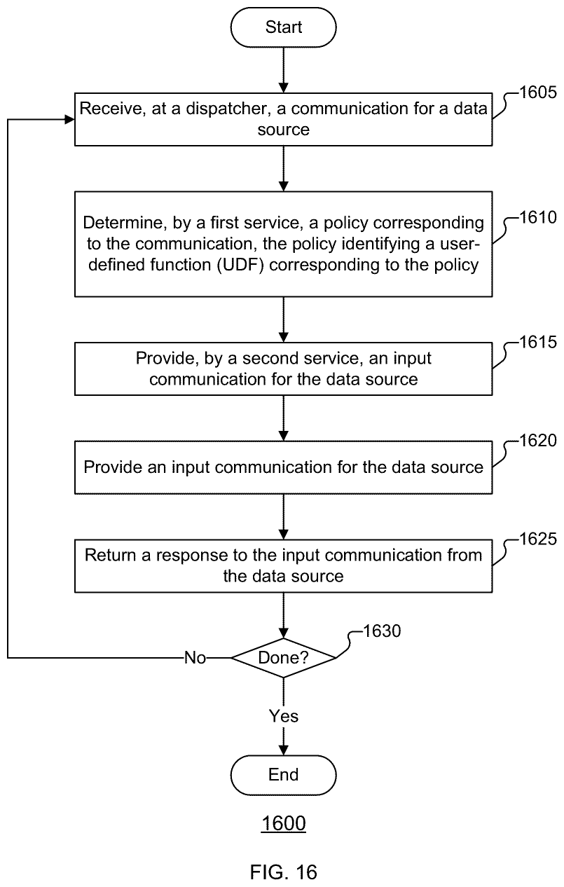

FIG. 16 is a flow diagram of a method for processing a query for data stored at a data source according to various embodiments. In some embodiments, process 1600 is implemented at least in part by system 1300 of FIG. 13 A and/or system 1350 of FIG. 13B. Process 1600 may be implemented by a sidecar, such as a proxy between via which a system (e.g., a client system) interfaces with a data source.

At 1605, the system receives, at a dispatcher, a communication for a data source. In some embodiments, 1605 is the same as, or similar to, 1505 of process 1500. For example, the sidecar may comprise a dispatcher that receives (e.g., intercepts) queries destined for the data source. At 1610, the system determine, by a first service, a policy corresponding to the communication. In some embodiments, 1610 is the same as, or similar to, 1510 of process 1500. As an example, a first service comprised in the sidecar determines a policy corresponding to the communication (e.g., the query). The first service may determine the policy to be enforced based at least in part on a context for the communication (e.g., the query context). At 1615, the system provides, by a second service an input communication for the data source. In some embodiments, the system (e.g., the sidecar) uses a second service to update (e.g., rewrite) the communication to obtain the input communication. For example, the sidecar uses the second service to rewrite the query based at least in part on the policy. The rewriting the query based at least in part on the policy to be enforced may include rewriting the query in a manner that the query indicates or references one or more UDFs to be applied at the data source in connection with processing the query. At 1620, the system provides an input communication for the data source. For example, the system sends the rewritten query to the data source for processing. At 1625, the system returns a response to the input communication from the data source. The system (e.g., the sidecar) receives a response from the data source, and in response to receiving the response from the data source, the system provides the response to the system from which the communication (e.g., the query) was received. The response to the query may be generated by enforcing the policy, including the data source applying of one or more UDFs indicated in or referenced by the policy. At 1630, a determination is made as to whether process 1600 is complete. In some embodiments, process 1600 is determined to be complete in response to a determination that no further queries are to be processed, a response has been provided to the communication, an administrator indicates that process 1600 is to be paused or stopped, etc. In response to a determination that process 1600 is complete, process 1600 ends. In response to a determination that process 1600 is not complete, process 1600 returns to 1605.

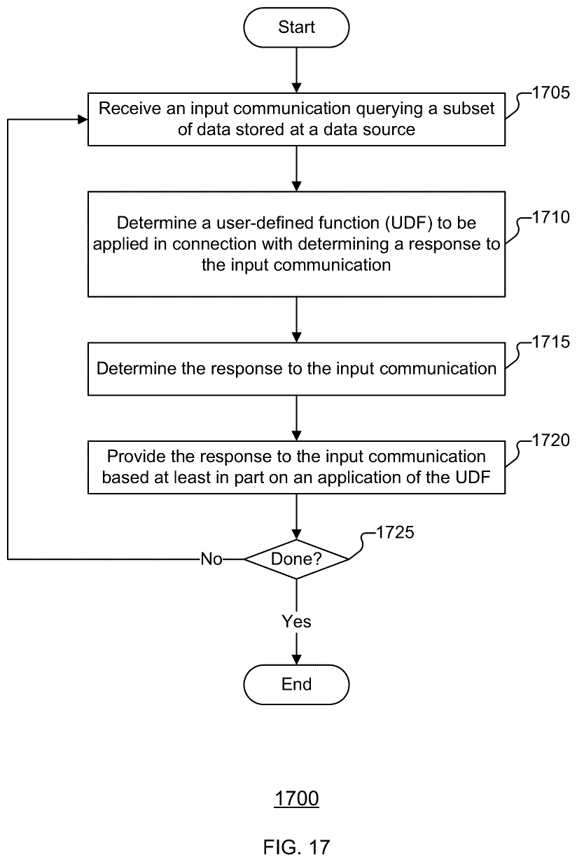

FIG. 17 is a flow diagram of a method for providing a response to a query for data stored at a data source according to various embodiments. In some embodiments, process 1700 is implemented at least in part by system 1300 of FIG. 13 A and/or system 1350 of FIG. 13B. Process 1700 may be implemented by a data source, such as in connection in response to receiving a communication from a sidecar that serves as a proxy between via which a system (e.g., a client system) interfaces with the data source.

In some embodiments, process 1700 is invoked in response to the data source receiving a query. For example, process 1700 is invoked in response to the sidecar sending a rewritten query (e.g., a query that indicates one or more UDFs to be applied) to the data source for processing.

At 1705, the system receives an input communication querying a subset of data stored at a data source. The data source receives the input communication from the sidecar. For example, the data source receives a rewritten query from the sidecar. The rewritten query may indicate one or more UDFs to be applied by the data source in connection with processing the query. At 1710, the system determines a UDF to be applied in connection with determining a response to the input communication. The data source can parse the rewritten query to identify one or more UDF(s) to be applied during processing of the query. At 1715, the system determines the response to the input communication. In response to determining that one or more UDFs are to be applied, the data source processes the query to obtain the response. The processing of the query includes applying the one or more UDFs indicated in the query. For example, the data source locally executes the UDFs in accordance with received rewritten query. At 1720, the system provides the response to the input communication based at least in part on an application of the UDF. In response to processing the query, including applying the one or UDFs during the processing, the data source returns the response to the sidecar, which in turn can provide the response to the system from which the query originated. At 1725, a determination is made as to whether process 1700 is complete. In some embodiments, process 1700 is determined to be complete in response to a determination that no further queries are to be processed, a response has been provided to the communication, an administrator indicates that process 1700 is to be paused or stopped, etc. In response to a determination that process 1700 is complete, process 1700 ends. In response to a determination that process 1700 is not complete, process 1700 returns to 1705.

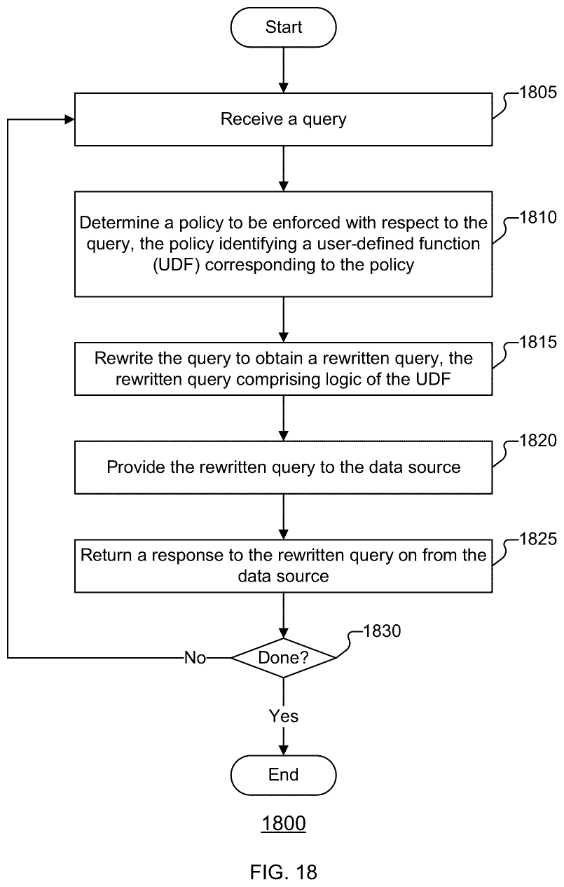

FIG. 18 is a flow diagram of a method for providing a response to a query for data stored at a data source according to various embodiments. In some embodiments, process 1800 is implemented at least in part by system 1350 of FIG. 13B. Process 1800 may be implemented by a sidecar, such as a proxy between via which a system (e.g., a client system) interfaces with a data source.

At 1805, the system receives a query. For example, the system receives a request for a query to be processed at a data store (e.g., a request to obtain data from a data store. In some embodiments, the sidecar receives (e.g., intercepts) a query pertaining to data stored in a data store. The query can be sent by another system (e.g., a client system) or service. The sidecar can serve/function as a proxy between the other system and the data source. The sidecar can invoke one or more services or processes to process the query.

At 1810, the system determines a policy corresponding to the communication. The policy identifies a UDF corresponding to the policy. In some embodiments, 1810 is similar to, or the same as 1510 of process 1500 or 1610 of process 1600.

At 1815, the system rewrites the query to obtain a rewritten query. The rewritten query comprises logic of the UDF. The rewritten query include the logic or function of the UDF without causing the data source to execute the UDF. For example, the rewritten query comprises the logic or functionality of the without identifying the UDF and/or without comprising an instruction that the data source call the UDF when processing the query. As an illustrative example, if a policy specifies that a masking UDF is to be applied with respect to a particular field (e.g., values for the field), the system rewrites the query to comprise the logic for masking the corresponding the field, for example, by specifying requesting that the field (e.g., values for the field) are returned as a particular format (e.g., the format which the sidecar determines is specified by the UDF).

At 1820, the system provides the rewritten query to the data source. For example, the system sends the rewritten query to the data source for processing. In response to receiving the rewritten query, the data source executes the rewritten query and returns a response to the system (e.g., the sidecar). The execution of the rewritten query can include processing the rewritten query without the data source calling/invoking the UDF during the processing. Rather, the logic of the rewritten query causes the UDF to be applied inherently by the data source when the rewritten query is executed by the data source.

At 1825, the system returns a response to the rewritten query from the data source.

At 1830, a determination is made as to whether process 1800 is complete. In some embodiments, process 1800 is determined to be complete in response to a determination that no further queries are to be processed, a response has been provided to the communication, an administrator indicates that process 1800 is to be paused or stopped, etc. In response to a determination that process 1800 is complete, process 1800 ends. In response to a determination that process 1800 is not complete, process 1800 returns to 1805.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving, at a sidecar, a communication for a data source;
determining, by the sidecar, a policy corresponding to the communication, the policy identifying a user-defined function (UDF) corresponding to the policy, the UDF being stored by the data source; and
invoking the UDF based at least in part on the policy using the sidecar.

2. The method of claim 1, wherein invoking the UDF comprises causing the data source to apply the UDF with respect to data stored in the data source.

3. The method of claim 2, wherein the UDF is applied in connection with determining a response to a query associated with the communication.

4. The method of claim 1, wherein the invoking the UDF comprises:
providing, by the sidecar, an input communication for the data source, the input communication based on the UDF and the communication;
providing the input communication to the data source; and
returning a response to the input communication from the data source.

5. The method of claim 4, wherein in response to receiving the input communication, the data source locally executes the UDF in connection with determining the response to the input communication.

6. The method of claim 1, wherein the invoking the UDF comprises:
rewriting the communication to obtain an input communication to be provided the data source, wherein rewriting the communication comprises modifying the communication to comprise logic associated with the UDF; and
providing the input communication to be provided to the data source.

7. The method of claim 6, wherein the data source processes the query to obtain a response to the communication with the policy having been enforced.

8. The method of claim 6, wherein the data source processes the query to perform the logic associated with the UDF comprised in the input communication without calling the data source calling the UDF.

9. The method of claim 1, wherein the sidecar serves as a proxy between a client and the data source.

10. The method of claim 9, wherein the communication is received from the client.

11. The method of claim 1, further comprising:
obtaining a response comprising at least a subset of data responsive to the communication for the data source.

12. The method of claim 11, further comprising:
providing the response to a client system from which the communication is received.

13. The method of claim 12, wherein providing the response to the client system comprises:
post-processing the response before sending the response to the client system.

14. The method of claim 1, wherein determining the policy corresponding to the communication comprises:
identifying one or more policies to be enforced with respect to obtaining a response to the communication, wherein the one or more policies are identified based at least in part on at least one characteristic associated with one or more of (i) the communication, (ii) a system from which the communication is received, (iii) a user or account associated with the system, and (iv) the data source.

15. The method of claim 14, wherein the determining the policy corresponding to the communication further comprises:
determining that a plurality of policies are to be enforced;
determining whether enforcement of the plurality of policies is expected to cause a conflict; and
determining a conflict resolution for the plurality of policies.

16. The method of claim 5, wherein the determining the policy corresponding to the communication further comprises:
in response to determining the conflict resolution for the plurality of policies, causing the conflict resolution to be implemented in connection with enforcement of the plurality of policies.

17. The method of claim 14, wherein determining the policy corresponding to the communication comprises:
determining that the one or more policies collectively identify a plurality of UDFs to be invoked;
determining whether an application of the plurality of UDFs is expected to cause a conflict; and
determining a conflict resolution for the plurality of UDFs.

18. The method of claim 17, wherein invoking the UDF based on the policy comprises:
causing the conflict resolution to be implemented in connection with the application of the plurality of UDFs.

19. The method of claim 17, wherein invoking the UDF based on the policy comprises:
determining an input communication for the data source, wherein the input communication includes an indication of the conflict resolution; and
providing the input communication to the data source.

20. The system of claim 19, wherein determining the input communication for the data source comprises:
determining a query associated with the communication for the data source; and
rewriting the query based at least in part on the conflict resolution and the plurality of UDFs.

21. The method of claim 1, wherein the UDF is stored in a UDF library at the data source.

22. The method of claim 1, wherein the UDF masks a subset of data returned from the data source in response to a query associated with the communication for the data source.

23. The method of claim 1, wherein the UDF obfuscates a subset of data returned from the data source in response to a query associated with the communication for the data source.

24. The method of claim 1, wherein the UDF causes a subset of data responsive to a query associated with the communication for the data source to be filtered from a response provided for the query.

25. A system, comprising:
a processor configured to:
receive, at a sidecar, a communication for a data source;
determine, by the sidecar, a policy corresponding to the communication, the policy identifying a user-defined function (UDF) corresponding to the policy, the UDF being stored by the data source; and
invoke the UDF based on the policy using the sidecar.

26. A computer program product embodied in a non-transitory computer readable medium and comprising computer instructions for:
receiving, at a sidecar, a communication for a data source;
determining, by the sidecar, a policy corresponding to the communication, the policy identifying a user-defined function (UDF) corresponding to the policy, the UDF being stored by the data source; and
invoking the UDF based on the policy using the sidecar.

27. A method, comprising:
receiving, at a dispatcher of a sidecar, a communication for a data source, the sidecar including the dispatcher and a plurality of services;
determining, by a first service, a policy corresponding to the communication, the policy identifying a user-defined function (UDF) corresponding to the policy;
providing, by a second service, an input communication for the data source, the input communication based on the UDF and the communication;
providing the input communication to the data source; and
returning a response to the input communication from the data source.

28. A method, comprising:
receiving, at a data source, an input communication querying a subset of data stored at the data source;
determining a user-defined function (UDF) to be applied in connection with determining a response to the input communication, wherein the UDF is determined based at least in part on an indication comprised in the input communication;
determining the response to the input communication, including applying the UDF; and
providing the response to the input communication based at least in part on an application of the UDF.

29. The method of claim 28, wherein the UDF is stored at the data source, and applying the UDF comprises executing the UDF locally at the data source.
